(19) United States
(12) Patent Application Publication
(10) Pub. No.: US 2019/0265578 A1
(43) Pub. Date: Aug. 29, 2019

(54) IMAGING APPARATUS

(71) Applicant: SONY CORPORATION, TOKYO (JP)

(72) Inventor: TOSHIKAZU MIYAO, KANAGAWA (JP)

(21) Appl. No.: 16/336,339

(22) PCT Filed: Sep. 29, 2017
(86) PCT No.: PCT/JP2017/035594

§ 371 Date: Mar. 25, 2019

(30) Foreign Application Priority Data
Nov. 7, 2016 (JP) 2016-217211

(51) Int. Cl. G03B 17/14; H04N 5/225; G03B 17/56

(52) U.S. Cl. CPC G03B 17/14; G03B 17/566; H04N 5/2253; H04N 5/2254

(57) ABSTRACT

To improve image quality by preventing an accessory from ratting against a mount section with the accessory locked to the mount section. A housing including a mount section to which an accessory is attachable; a rotation operating section rotatably supported by the housing; and a locking section configured to hold the accessory such that the accessory is undroppable from the mount section are included. A rotation position of the rotation operating section includes: in order of a rotation in one direction, an attachable position in which the accessory is attachable to the mount section; a locking position in which the accessory is held by the locking section such that the accessory is undroppable from the mount section; and a fixing position in which the accessory is held in close contact with the mount section, the fixing position being a rotation end of the rotation operating section.

### TECHNICAL FIELD

The present technology relates to a technical field of an imaging apparatus in which an accessory is attachable to and detachable from a mount section.

### CITATION LIST

### Patent Literature

[PTL 1]

Japanese Patent Laid-Open No. Hei 08-43910

### BACKGROUND ART

In various imaging apparatuses such as video cameras and still cameras, an accessory such as an interchangeable lens is attachable to and detachable from a mount section. Attaching the interchangeable lens to the mount section leads to improved functionality, for example. Furthermore, in some cases, the interchangeable lens is attached to the mount section through an adapter, and the adapter is also used as an accessory in the imaging apparatus.

For the imaging apparatus which such an accessory is attachable to and detachable from, a so-called bayonet method and a so-called spigot method are available as a method to attach the accessory to the imaging apparatus (for example, see PTL 1). With the bayonet method, rotating the entire accessory with respect to the imaging apparatus engages a coupling section of the accessory with an engagement section of the imaging apparatus. With the spigot method, operating an operation lever provided in the accessory engages the coupling section of the accessory with the engagement section of the imaging apparatus.

With the bayonet method, the accessory is attached to the imaging apparatus by rotating the entire accessory by a certain angle while pressing the accessory from the front against the mount section of the imaging apparatus.

This bayonet method simplifies the structure of the accessory since no operation lever is used. However, since the entire accessory is rotated with respect to the imaging apparatus, it is necessary to provide each section of the imaging apparatus in a position deviated from a rotation path of the accessory in consideration of avoidance of the interference with the accessory, and there is a possible decrease in a degree of flexibility in the design of the imaging apparatus.

By contrast, with the spigot method, the accessory is attached to the imaging apparatus by operating and rotating the operation lever by a certain angle while pressing the accessory from the front against a front surface (mount section) of the imaging apparatus.

With this spigot method, the accessory is attached to the imaging apparatus by operating the operation lever, and the entire accessory does not need to be rotated with respect to the imaging apparatus. Thus, the spigot method has an advantage of a high degree of flexibility in the design of the imaging apparatus. Furthermore, since the entire accessory, which is heavy in weight, does not need to be rotated, the spigot method also has an advantage that the accessory can be easily attached to or detached from the imaging apparatus.

### SUMMARY

### Technical Problems

Incidentally, the imaging apparatus as described above in which the accessory is attachable to and detachable from the mount section includes a lock mechanism. The lock mechanism locks the accessory to the mount section to prevent the accessory from dropping off from the mount section. For example, in an imaging apparatus recited in PTL 1, an operation of rotating an operation lever of an interchangeable lens engages a coupling section (engagement groove) of the operation lever with a locking section (lock lever) of the imaging apparatus to perform locking. An operation of pressing an unlock button (lens attaching/detaching button) releases the engagement of the locking section with respect to the coupling section, thereby releasing the locked state.

However, although locking the accessory to the mount section can prevent the accessory from dropping off from the mount section, in a case where the accessory rattles against the mount section in the locked state, there is a possibility that the accessory is displaced with respect to the imaging apparatus and the optical axis inclination or the like occurs at the time of photographing, for example, and the quality of the photographed image is deteriorated.

In view of the foregoing, an object of an imaging apparatus according to the present technology is to solve the above-described issue and to improve image quality by preventing an accessory from ratting against a mount section with the accessory locked to the mount section.

### Solution to Problems

First, an imaging apparatus according to the present technology includes: a housing including a mount section to which an accessory is attachable; a rotation operating section rotatably supported by the housing; and a locking section configured to hold the accessory such that the accessory is undroppable from the mount section, in which a rotation position of the rotation operating section includes: in order of a rotation in one direction, an attachable position in which the accessory is attachable to the mount section; a locking position in which the accessory is held by the locking section such that the accessory is undroppable from the mount section; and a fixing position in which the accessory is held in close contact with the mount section, the fixing position being a rotation end of the rotation operating section.

As a result, the rotation of the rotation operating section in one direction from the attachable position fixes the accessory to the mount section after locking the accessory to the mount section.

Second, it is desirable that in the above-described imaging apparatus according to the present technology, the mount section includes a thread engagement section, the rotation operating section includes: a thread groove section whose thread engagement state with respect to the thread engagement section is changed according to a rotation angle with respect to the housing; and an engagement section configured to be engaged with a coupling section included in the accessory, and the accessory is fixed to the mount section by the engagement section being pressed against the coupling section according to the thread engagement state of the thread groove section with respect to the thread engagement section.

As a result, with the accessory fixed to the mount section, the engagement section is pressed against the coupling section and the accessory is pressed against the mount section.

Third, it is desirable that in the above-described imaging apparatus according to the present technology, the rotation operating section includes an operation member and an engagement member joined to each other, and the thread groove section and the engagement section are formed in the engagement member.

As a result, since the thread groove section and the engagement section are formed in one member, a positional relationship between the thread groove section and the engagement section does not change.

Fourth, it is desirable that the above-described imaging apparatus according to the present technology further includes a joining plate joining the operation member and the engagement member to each other, in which a switch operation section is attached to the joining plate.

As a result, the joining plate has a function of joining the operation member and the engagement section to each other, while functioning as an attachment plate to which the switch operation section is attached.

Fifth, it is desirable that the above-described imaging apparatus according to the present technology further includes an operation switch configured to switch between a communication-enabled mode in which data communication with the accessory is enabled and a communication-disabled mode in which the data communication with the accessory is disabled, in which the operation switch is operated along with the rotation of the rotation operating section.

As a result, the communication-enabled mode and the communication-disabled mode are switched according to the attachment or detachment state of the accessory with respect to the mount section by the rotation of the rotation operating section.

Sixth, it is desirable that in the above-described imaging apparatus according to the present technology, the communication-enabled mode is set when the operation switch is made into a predetermined detection state while the rotation operating section is being rotated from the attachable position to the locking position.

As a result, the communication-enabled mode is set while the rotation operating section is being rotated from the attachable position to the locking position. Thus, it is possible to always communicate with the accessory with the accessory locked to the mount section.

Seventh, it is desirable that the above-described imaging apparatus according to the present technology further includes a contact configured to detect, when a terminal of the accessory is coupled, that the data communication with the accessory has been set to enabled, in which the communication-enabled mode is set when the operation switch is made into a predetermined detection state with the terminal coupled to the contact.

As a result, the communication-enabled mode is set when the terminal is coupled to the contact and the operation switch is made into the predetermined detection state by the operation of rotating the rotation operating section. Thus, only when the accessory is attached to the mount section in an appropriate state and the terminal is coupled to the contact, the communication-enabled mode is set.

Eighth, it is desirable that in the above-described imaging apparatus according to the present technology, a rotation angle of the rotation operating section from the locking position to the fixing position is 15 degrees or more and 25 degrees or less.

As a result, the operation of rotating the rotation operating section by 15 degrees or more and 25 degrees or less from the locking position fixes the accessory to the mount section. Thus, it is possible to effortlessly operate the rotation operating section from the locking position to the fixing position and fix the accessory without changing the hand.

Ninth, it is desirable that in the above-described imaging apparatus according to the present technology, the locking section is provided in a position in which at least a part of the locking section is covered by the accessory locked to the mount section.

As a result, with the accessory locked to the mount section, at least a part of the locking section is covered by the accessory. Thus, the locking section is less likely to be touched by the hand during the use of the imaging apparatus such as a photographing action, and the accessory is less likely to be erroneously unlocked.

Tenth, it is desirable that in the above-described imaging apparatus according to the present technology, the locking section is movable between a rotation allowable position in which the rotation of the rotation operating section is allowed and a rotation restricting position in which the rotation of the rotation operating section is restricted, and the rotation operating section includes a restricted section with which the locking section moved to the rotation restricting position is contactable in the locking position.

As a result, the accessory is locked to the mount section by the locking section moved to the rotation restricting position.

Eleventh, it is desirable that the above-described imaging apparatus according to the present technology further includes a biasing spring configured to bias the locking section in a direction in which the locking section is moved from the rotation allowable position to the rotation restricting position; and an action lever configured to be turnable with respect to the housing and hold the locking section in the rotation allowable position.

As a result, since the locking section is held by the action lever in the rotation allowable position and the movement of the locking section to the rotation restricting position is restricted, it is not necessary to hold the locking section when rotating the rotation operating section from the locking position to the attachable position.

Twelfth, it is desirable that the above-described imaging apparatus according to the present technology further includes a spring member configured to bias the action lever in one turning direction, in which the locking section is moved toward the rotation restricting position by a biasing force of the biasing spring and a biasing force of the spring member.

As a result, when the locking section is moved to the rotation restricting position, not only the biasing force of the biasing spring but also the biasing force of the spring member that biases the action lever are applied to the locking section.

Thirteenth, it is desirable that in the above-described imaging apparatus according to the present technology, a spring constant of the spring member is larger than a spring constant of the biasing spring, when the rotation operating section is rotated from the attachable position to the fixing position, the biasing force of the spring member is exerted on the locking section through the action lever in the direction in which the locking section is moved from the rotation allowable position to the rotation restricting position, and when the rotation operating section is rotated from the fixing position to the attachable position, the biasing force of the spring member is exerted on the locking section through the action lever in a direction in which the locking section is moved from the rotation restricting position to the rotation allowable position.

As a result, when the rotation operating section is rotated in the opposite direction, the biasing force of the spring member is exerted on the locking section in the corresponding opposite direction.

Fourteenth, it is desirable that in the above-described imaging apparatus according to the present technology, in the attachable position, the restricted section restricts movement of the locking section toward the rotation restricting position, the locking section being biased by the biasing spring.

As a result, the locking section is moved to the rotation restricting position by the restricted section that is contacted by the locking section and that is involved in the restriction of the rotation of the accessory.

Fifteenth, it is desirable that in the above-described imaging apparatus according to the present technology, the action lever is provided in a position in which at least a part of the action lever is covered by the accessory locked to the mount section.

As a result, with the accessory locked to the mount section, at least a part of the action lever is covered by the accessory. Thus, the action lever is less likely to be touched by the hand during the use of the imaging apparatus such as the photographing action, and the accessory is less likely to be erroneously unlocked.

Sixteenth, it is desirable that the above-described imaging apparatus according to the present technology further includes: a knob section included in the locking section; and a cover including an insertion hole into which the knob section is inserted and covering the action lever and a portion of the locking section excluding the knob section.

As a result, since the cover covers the action lever and the portion of the locking section excluding the knob section, the locking section and the action lever are less likely to be touched by the hand during the use of the imaging apparatus such as the photographing action.

Seventeenth, it is desirable that in the above-described imaging apparatus according to the present technology, the accessory includes an interchangeable lens.

As a result, the rotation of the rotation operating section in one direction from the attachable position fixes the interchangeable lens to the mount section after locking the interchangeable lens to the mount section.

### Advantageous Effect of Invention

According to the present technology, the rotation of a rotation operating section in one direction from an attachable position fixes an accessory to a mount section after locking the accessory to the mount section. Thus, it is possible to improve image quality by preventing the accessory from rattling against the mount section with the accessory locked to the mount section.

It is noted that the effects described in the present specification are merely examples and not limitative, and other effects may be provided.

### BRIEF DESCRIPTION OF DRAWINGS

FIG. 1 depicts, together with FIGS. 2 to 28, an embodiment of an imaging apparatus according to the present technology and is a perspective view depicting an interchangeable lens and the imaging apparatus.

FIG. 2 is a perspective view depicting a part of the imaging apparatus with a cover separated therefrom.

FIG. 3 is an exploded perspective view depicting a part of the imaging apparatus.

FIG. 4 is a rear view of a panel section and the like.

FIG. 5 is a cross-sectional view depicting a state where a thread groove section of an engagement member is threadedly engaged with a thread engagement section of a mount section.

FIG. 6 is a front view of the panel section and the like.

FIG. 7 is an exploded perspective view depicting a lock lever, an action lever, and the like.

FIG. 8 is a front view depicting the lock lever, the action lever, and the like.

FIG. 9 is a perspective view depicting a rear end portion of the interchangeable lens.

FIG. 10 depicts, together with FIGS. 11 to 26, actions of attaching and detaching the interchangeable lens to and from the mount section and is a front view depicting an initial state of the lock lever and the like.

FIG. 11 is a cross-sectional view depicting an initial state of the engagement member and the like.

FIG. 12 is a rear view depicting a positional relationship between a switch operation section and an operation switch in the initial state.

FIG. 13 is a cross-sectional view depicting a state where a coupling section of the interchangeable lens is inserted into the engagement member of an operation lever.

FIG. 14 is a rear view depicting a state where the coupling section of the interchangeable lens is inserted into the engagement member of the operation lever.

FIG. 15 is a front view depicting a state of the lock lever and the like immediately after the operation lever has been rotated in one direction.

FIG. 16 is a rear view depicting, continuing from FIG. 14, a state where the operation lever is rotated in one direction.

FIG. 17 is a front view depicting, continuing from FIG. 15, a state of the lock lever and the like when the operation lever is rotated in one direction.

FIG. 18 is a rear view depicting, continuing from FIG. 16, a state where the operation lever is rotated in one direction and the operation switch is off.

FIG. 19 is a front view depicting, continuing from FIG. 17, a state where the operation lever is rotated in one direction to a locking position and the operation lever is locked by the lock lever.

FIG. 20 is a front view depicting, continuing from FIG. 19, a state of the lock lever and the like when the operation lever is rotated in one direction to a fixing position.

FIG. 21 is a rear view depicting, continuing from FIG. 18, a state where the operation lever is rotated in one direction.

FIG. 22 is a cross-sectional view depicting a state where the operation lever is rotated in one direction to the fixing position and the interchangeable lens is fixed to the mount section.

FIG. 23 is a front view depicting a state of the lock lever and the like when the operation lever is rotated in the other direction from the fixing position.

FIG. 24 is a front view depicting a state where the lock lever is moved from a rotation restricting position to a rotation allowable position.

FIG. 25 is a front view depicting, continuing from FIG. 24, a state where the operation lever is rotated in the other direction and the action lever is turned.

FIG. 26 is a front view depicting, continuing from FIG. 25, a state of the lock lever and the like when the operation lever is rotated in the other direction.

FIG. 27 is a time chart for actions when the interchangeable lens is attached to the mount section.

FIG. 28 is a block diagram of the imaging apparatus.

### DESCRIPTION OF EMBODIMENT

Hereinafter, a mode for carrying out the present technology will be described with reference to the accompanying drawings.

In the embodiment described below, an imaging apparatus according to the present technology is applied to a video camera.

It is noted that the scope of the application of the present technology is not limited to the video camera. The present technology can be widely applied to various other imaging apparatuses such as still cameras other than video cameras, for example.

In the following description, the front, rear, upper, lower, right, and left directions are assumed to be the directions viewed from a photographer at the time of photographing with the video camera. Consequently, the object side is the front, while the image surface side is the rear.

It is noted that the front, rear, upper, lower, right, and left directions described below are used for convenience of description, and the directions are not limited to these directions in carrying out the present technology.

Furthermore, a group of lenses described below may include one or a plurality of lenses. Alternatively, the group of lenses may include these one or plurality of lenses and other optical devices such as an aperture and an iris.

In addition, hereinafter, an interchangeable lens is exemplified as an accessory that is attachable to and detachable from the imaging apparatus; however, the accessory is not limited to the interchangeable lens. For example, the accessory may be another accessory such as an adapter for attaching the interchangeable lens to the imaging apparatus.

### <Configuration of Imaging Apparatus>

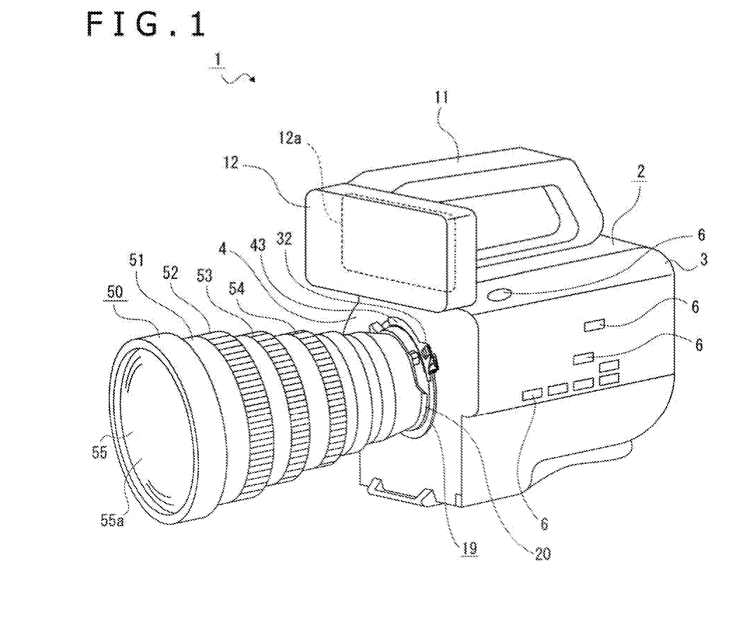

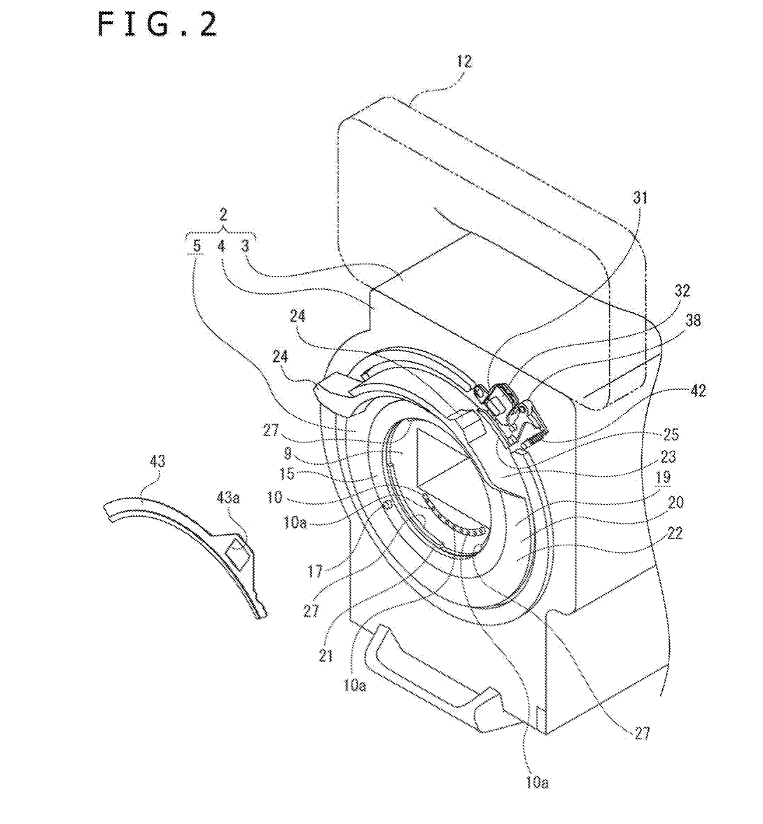

An imaging apparatus 1 includes each necessary section arranged inside and outside a housing 2 (see FIGS. 1 and 2).

The housing 2 includes a box-shaped main body section 3, a panel section 4, and a mount section 5. The main body section 3 has an opening at the front thereof. The panel section 4 is attached to a front end portion of the main body section 3. The mount section 5 is attached to a front surface of the panel section 4. It is noted that the mount section 5 may be formed integrally with the panel section 4 and provided as a part of the panel section 4.

Various operation sections 6, 6, . . . are arranged in the main body section 3. As the operation sections 6, 6, . . . , a power supply button, a photographing button, a zoom knob, a mode switching knob, and the like are provided, for example.

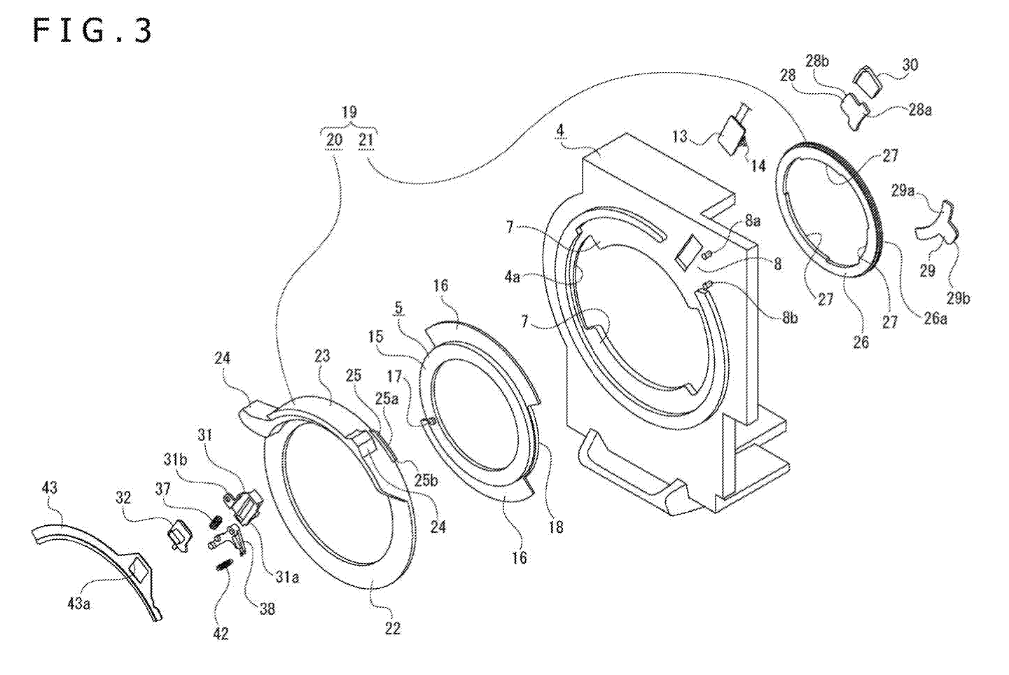

An opening 4a is formed in the front surface of the panel section 4 (see FIG. 3). Arc-shaped mount attachment sections 7 and 7 extend inward in an inner circumferential portion of the panel section 4 and are provided apart from each other in the circumferential direction. On an upper end side of the panel section 4, a mechanism arrangement section 8 is provided on an outer circumferential side of the mount attachment section 7 positioned on an upper side.

A support shaft section 8a and a spring hook protruding section 8b are provided in the mechanism arrangement section 8. Each of the support shaft section 8a and the spring hook protruding section 8b protrudes forward.

An imaging device such as a CCD (charge coupled device) or a complementary metal-oxide semiconductor (CMOS) is arranged inside the housing 2. The imaging device, not illustrated, is positioned behind the opening 4a.

A contact arrangement section 9 is provided on a rear side of the opening 4a inside the housing 2 (see FIG. 2). The contact arrangement section 9 faces forward. A contact section 10 is arranged in the contact arrangement section 9. The contact section 10 is arranged in a lower end portion of the contact arrangement section 9 and is formed in an arc shape. The contact section 10 includes a plurality of contacts 10a, 10a, . . . , and is arranged in a position along the opening 4a. The plurality of contacts 10a, 10a, . . . are positioned apart from each other in the longitudinal direction (circumferential direction).

A handle section 11 is provided on an upper surface side of the main body section 3 (see FIG. 1). A display 12 is, for example, turnably supported on an upper surface at a front end portion of the housing 2. The display 12 includes a display surface 12a facing rearward. A user is able to perform photographing and the like while holding the handle section 11 and visually recognizing an image displayed on the display surface 12a of the display 12.

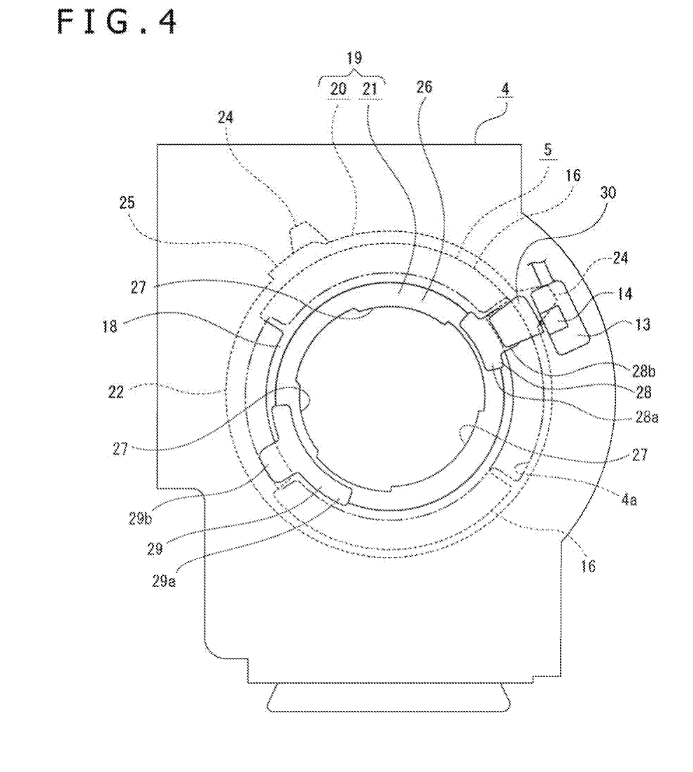

A substrate 13 is attached to a rear surface of the panel section 4. An operation switch 14 is arranged on the substrate 13 (see FIG. 4). The operation switch 14 has a function of switching between a communication-enabled mode and a communication-disabled mode. Data communication between the interchangeable lens functioning as an accessory, described later, and the imaging apparatus 1 is enabled in the communication-enabled mode and disabled in the communication-disabled mode.

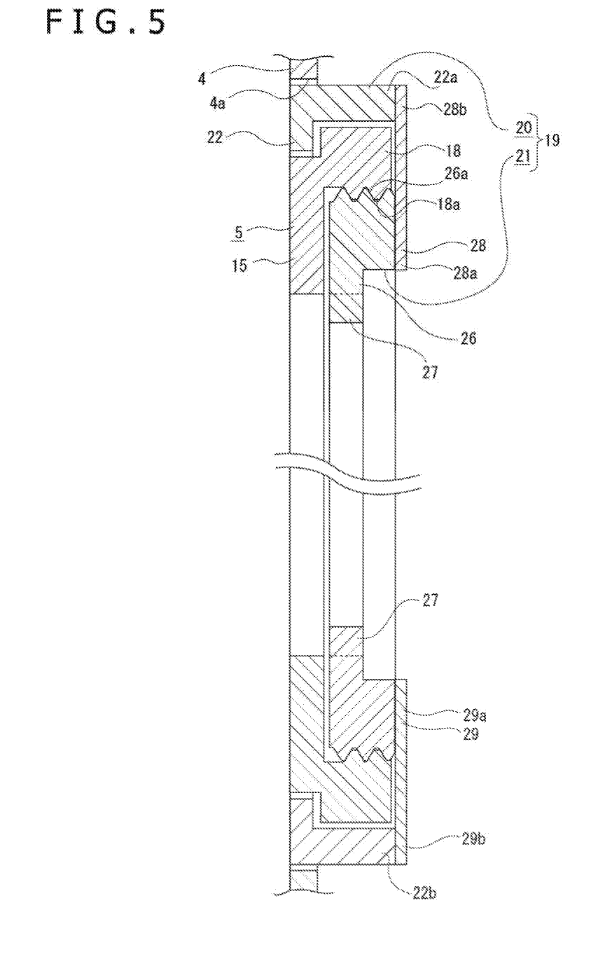

As depicted in FIGS. 2 and 3, the mount section 5 includes a base section 15, attached sections 16 and 16, an alignment pin 17, and a circular section 18. The base section 15 faces in the front-rear direction and is formed in a plate-like annular shape. The attached sections 16 and 16 have an arc shape and are provided on an outer circumferential side of the base section 15. The alignment pin 17 protrudes forward from a front surface of the base section 15. The circular section 18 protrudes rearward from an outer circumferential portion of the base section 15. The attached sections 16 and 16 are positioned apart from each other in the circumferential direction. An inner circumferential surface of the circular section 18 is formed as a thread engagement section 18a (see FIG. 5). A thread groove is formed in the thread engagement section 18a.

Each of the attached sections 16 and 16 of the mount section 5 is attached from the front to the corresponding one of the mount attachment sections 7 and 7 by a screw or the like (see FIGS. 2, 3, and 5).

An operation lever 19 is rotatably supported by the mount section 5. The operation lever 19 functions as a rotation operating section. The operation lever 19 includes an operation member 20 and an engagement member 21 coupled to each other in the front and rear. Consequently, the operation member 20 and the engagement member 21 are integrally rotated with respect to the mount section 5 and the housing 2 to which the mount section 5 is attached.

The operation member 20 includes an annular section 22, a projecting section 23, finger-hook protruding sections 24 and 24, and a restricted section 25. The annular section 22 has an annular shape. The projecting section 23 has an arc shape and protrudes forward from a part of an outer circumferential portion of the annular section 22. Each of the finger-hook protruding sections 24 and 24 protrudes outward from the projecting section 23. The restricted section 25 protrudes outward from a part of an outer circumferential surface of the annular section 22.

The annular section 22 is slightly larger than the base section 15 of the mount section 5. Coupling protruding sections 22a and 22b protrude rearward and are provided apart from each other on the annular section 22 in the circumferential direction.

The restricted section 25 is formed in a plate shape and is thin in the front and rear thickness. The restricted section 25 is formed in a shape extending in the circumferential direction of the annular section 22. The restricted section 25 has an outer circumferential edge formed as a lever holding section 25a and a left side edge formed as a stopped section 25b.

The engagement member 21 includes a ring-shaped section 26 and engagement sections 27, 27, and 27. The ring-shaped section 26 is formed in a substantially annular shape and is slightly smaller than the base section 15 of the mount section 5. Each of the engagement sections 27, 27, and 27 has an arc shape and protrudes inward from the ring-shaped section 26. A thread groove section 26a is formed on an outer circumferential surface of the ring-shaped section 26. The engagement sections 27, 27, and 27 are positioned apart from each other in the circumferential direction.

The operation member 20 and the engagement member 21 are joined to each other by joining plates 28 and 29 in the front-rear direction with the mount section 5 interposed between the operation member 20 and the engagement member 21 (see FIGS. 3 to 5). The joining plates 28 and 29 include first fixed sections 28a and 29a, respectively. Each of the first fixed sections 28a and 29a has an arc shape. The joining plates 28 and 29 include second fixed sections 28b and 29b, respectively. Each of the second fixed sections 28b and 29b protrudes outward from the first fixed sections 28a and 29a, respectively. The joining plates 28 and 29 are moved in the circumferential direction along with the rotation of the operation lever 19.

The first fixed sections 28a and 29a of the joining plates 28 and 29 are fixed to a rear surface of the ring-shaped section 26 of the engagement member 21. The second fixed sections 28b and 29b of the joining plates 28 and 29 are fixed to the coupling protruding sections 22a and 22b of the annular section 22 of the operation member 20, respectively. With the joining plates 28 and 29 fixed to the operation member 20 and the engagement member 21, each of the second fixed sections 28b and 29b is positioned between the attached sections 16 and 16 of the mount section 5.

The operation lever 19 includes the operation member 20 and the engagement member 21 joined to each other by the joining plates 28 and 29 with the mount section 5 interposed between the operation member 20 and the engagement member 21. In this state, the operation member 20 is positioned on the outer circumferential side of the base section 15 of the mount section 5 while at least the engagement sections 27, 27, and 27 of the engagement member 21 are positioned on an inner circumferential side of the base section 15 of the mount section 5. In this case, the thread groove section 26a of the engagement member 21 is threadedly engaged with the thread engagement section 18a of the mount section 5 (see FIG. 5). Consequently, the thread engagement position of the thread groove section 26a with respect to the thread engagement section 18a is changed according to the rotation position of the operation lever 19. When the thread engagement position is changed, the operation lever 19 is moved in the front-rear direction along with the rotation.

A switch operation section 30 is attached to a rear surface of the second fixed section 28b of the joining plate 28 by a screw or the like (see FIG. 4). A part of the switch operation section 30 protrudes outward from the second fixed section 28b. The switch operation section 30 is moved in the circumferential direction when the joining plate 28 is moved along with the rotation of the operation lever 19.

When the switch operation section 30 is moved in the circumferential direction along with the rotation of the operation lever 19, the operation switch 18 is operated by the switch operation section 30.

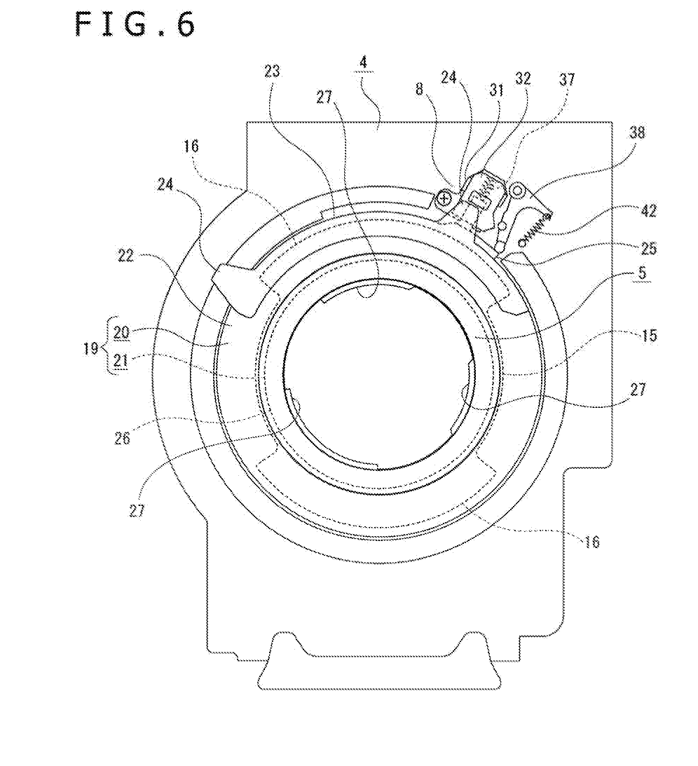

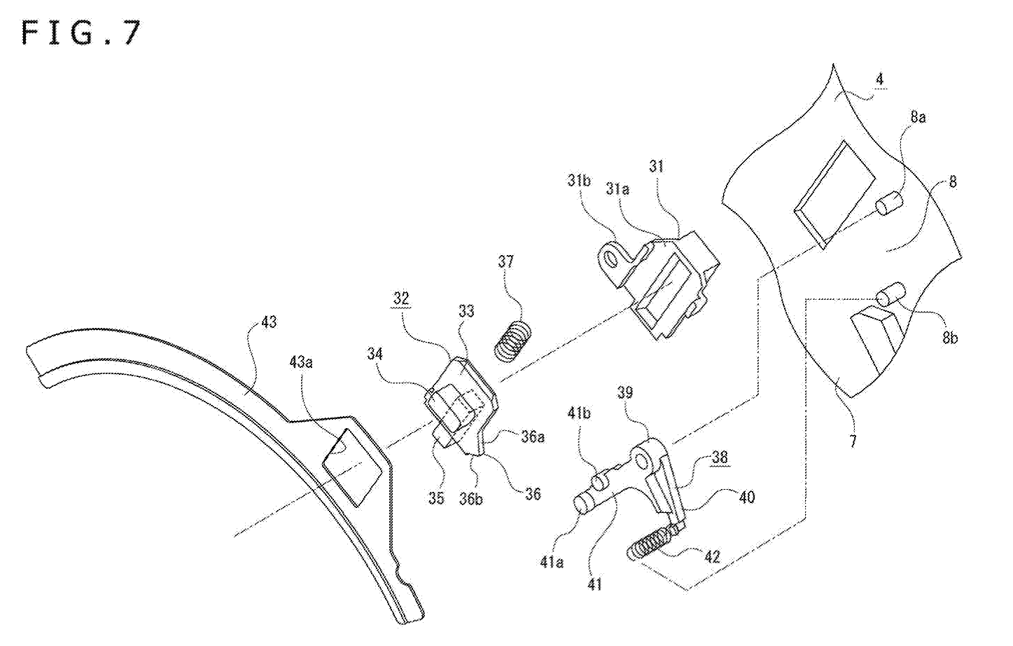

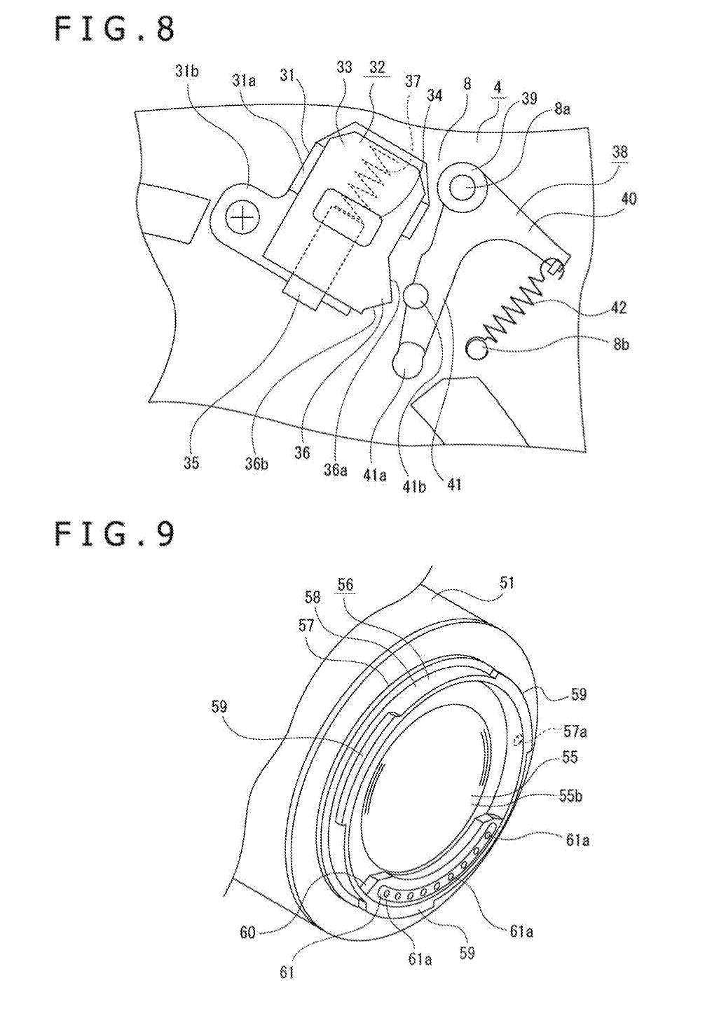

A support case 31 is attached to the mechanism arrangement section 8 of the panel section 4 (see FIGS. 6 to 8). The support case 31 includes a case section 31a and an attached protruding section 31b. The case section 31a has an opening at the front thereof. The attached protruding section 31b protrudes outward from the case section 31a. The attached protruding section 31b of the support case 31 is attached to the mechanism arrangement section 8 by a screw or the like.

A lock lever 32 is movably supported by the support case 31. The lock lever 32 functions as a locking section. The lock lever 32 includes a block-like base body section 33, a knob section 34, a sliding section 35, and an acted section 36. The knob section 34 protrudes forward from the base body section 33. The sliding section 35 protrudes substantially downward from the base body section 33. The acted section 36 protrudes laterally from a lower end portion of the base body section 33. The lock lever 32 is movable in the radial direction of the annular section 22 of the operation member 20 and is moved between a rotation allowable position and a rotation restricting position. The rotation allowable position is at the outermost in the radial direction while the rotation restricting position is at the innermost in the radial direction.

It is noted that in the lock lever 32, the sliding section 35 may be provided as a separate member from the other sections. By providing the sliding section 35 as a separate member, the sliding section 35 can include a material with higher strength than the other sections, while the other sections can include a material which is less expensive than the sliding section 35. Accordingly, it is possible to increase the strength of only the necessary section while reducing the costs.

The acted section 36 is formed in an outwardly convex shape with two inclined edges. The inclined edge on the upper side is formed as a first acted edge 36a, while the inclined edge on the lower side is formed as a second acted edge 36b.

A biasing spring 37 is arranged inside the support case 31 and biases the lock lever 32 in the direction from the rotation allowable position to the rotation restricting position.

In the mechanism arrangement section 8 of the panel section 4, an action lever 38 is turnably supported in a position adjacent to the lock lever 32.

The action lever 38 includes a turning shaft section 39, a first arm section 40, and a second arm section 41. The action lever 38 turns about the turning shaft section 39 into which the support shaft section 8a is inserted. The first arm section 40 and the second arm section 41 protrude in different directions from the turning shaft 39. The first arm section 40 and the second arm section 41 are formed substantially perpendicular to each other. A spring member 42 is supported between a distal end portion of the first arm section 40 and the spring hook protruding section 8b of the mechanism arrangement section 8. The spring constant of the spring member 42 is larger than the spring constant of the biasing spring 37. The action lever 38 is turnable about the support shaft section 8a. The spring member 42 biases the second arm section 41 in the turning direction in which the second arm section 41 approaches the lock lever 32.

A first action protruding section 41a and a second action protruding section 41b are provided on the second arm section 41 and provided apart from each other. Each of the first action protruding section 41a and the second action protruding section 41b protrudes forward. The first action protruding section 41a is positioned closer to a distal end side of the second arm section 41 than the second action protruding section 41b is.

A cover 43 is attached to the panel section 4 from the front. An insertion hole 43a is formed in the cover 43. The cover 43 closes the biasing spring 37, the action lever 38, the spring member 42, and a portion of the lock lever 32 excluding the knob section 34 from the front. The knob section 34 is inserted into the insertion hole 43a and protrudes forward from the cover 43.

As described above, the imaging apparatus 1 includes the cover 43. The cover 43 includes the insertion hole 43a into which the knob section 34 of the lock lever 32 is inserted, and covers the action lever 38, the biasing spring 37, the spring member 42, and the portion of the lock lever 32 excluding the knob section 34.

Consequently, since the cover 43 covers the action lever 38, the biasing spring 37, the spring member 42, and the portion of the lock lever 32 excluding the knob section 34, it is less likely that the lock lever 32, the action lever 38, the biasing spring 37, and the spring member 42 are touched by a hand during the use of the imaging apparatus 1 such as a photographing action. Accordingly, it is possible to prevent the lock lever 32, the action lever 38, and the like from dropping off from the housing 2 during the use of the imaging apparatus 1, while securing a favorable function of the lock lever 32.

### <Configuration of Interchangeable Lens>

An interchangeable lens 50 is attachable to and detachable from the mount section 5 of the imaging apparatus 1 (see FIGS. 1 and 9). The interchangeable lens 50 functions as an accessory.

The interchangeable lens 50 includes each necessary section arranged inside and outside an outer cylinder 51.

Adjustment rings 52, 53, and 54 are rotatably supported apart from each other in the front and rear on an outer circumferential surface of the outer cylinder 51 (see FIG. 1). The adjustment rings 52, 53, and 54 have functions of adjusting the focusing, the zooming, and the light amount of the aperture, for example.

A group of a plurality of lenses 55, 55, . . . are arranged apart from each other in the optical axis direction inside the outer cylinder 51. As a part of the group of lenses 55, a front-side lens 55a and a rear-side lens 55b are arranged inside the outer cylinder 51. The front-side lens 55a is positioned at the frontmost. The rear-side lens 55b is positioned at the rearmost.

A coupling ring 56 is attached to a rear surface of the outer cylinder 51 (see FIG. 9). The coupling ring 56 includes a base ring section 57, a joining section 58, and coupling sections 59, 59, and 59. The base ring section 57 has a substantially annular shape. The joining section 58 has a cylindrical shape and protrudes rearward from an inner circumferential portion of the base ring section 57. Each of the coupling sections 59, 59, and 59 has an arc shape and protrudes outward from a rear end portion of the joining section 58. An alignment hole 57a is formed in the base ring section 57.

A terminal arrangement section 60 is provided on an inner side of the coupling ring 56 in a rear end portion of the outer cylinder 51. A terminal section 61 is arranged in the terminal arrangement section 60. The terminal section 61 is formed in an arc shape and includes a plurality of terminals 61a, 61a, The plurality of terminals 61a, 61a, . . . are positioned apart from each other in the longitudinal direction (circumferential direction).

<Actions of Attaching and Detaching Interchangeable Lens to and from Mount Section>

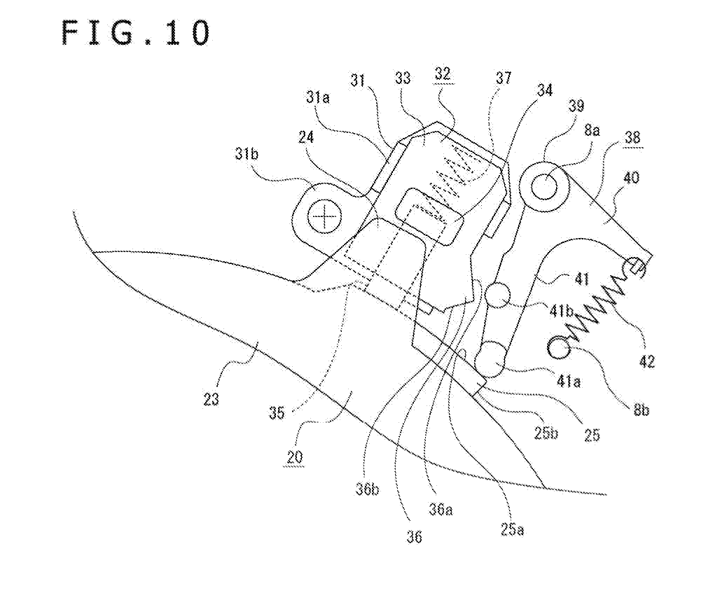

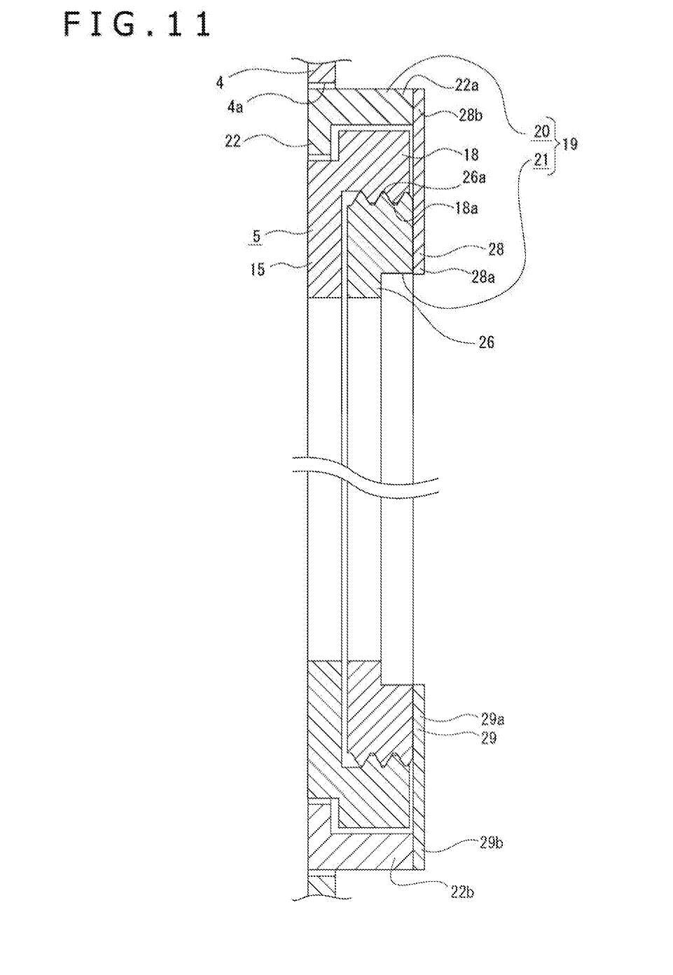

Hereinafter, description will be made with regard to actions of attaching and detaching the interchangeable lens 50 to and from the mount section 5 (see FIGS. 10 to 26).

The interchangeable lens 50 is attached to or detached from the mount section 5 by the rotation of the operation lever 19. As the rotation positions of the operation lever 19 at the time of attachment or detachment of the mount section 5, an attachable position, a locking position, and a fixing position are set. In the attachable position, the interchangeable lens 50 is attachable to the mount section 5. In the locking position, the interchangeable lens 50 is held and locked by the lock lever 32 such that the interchangeable lens 50 is undroppable from the mount section 5. In the fixing position, the interchangeable lens 50 is held in close contact with the mount section 5. The fixing position is a rotation end of the operation lever 19. The locking position is between the attachable position and the fixing position. An operation of rotating (an action of rotating) the operation lever 19 is performed between the attachable position and the fixing position when the interchangeable lens 50 is attached to or detached from the mount section 5. It is noted that the interchangeable lens 50 is also detachable from the mount section 5 in the attachable position.

First, description will be made with regard to the initial state of each section before the interchangeable lens 50 is attached to the mount section 5 (see FIGS. 10 to 14).

In the initial state, the operation lever 19 is positioned in the attachable position (see FIG. 10). In this case, the thread groove section 26a formed in the engagement member 21 of the operation lever 19 is threadedly engaged with the thread engagement section 18a formed in the mount section 5 and is positioned at the frontmost within a front-rear movement range. The ring-shaped section 26 of the engagement member 21 is positioned closest to the base section 15 of the mount section 5 (see FIG. 11).

In the initial state where the operation lever 19 is positioned in the attachable position, the sliding section 35 of the lock lever 32 is pressed against the lever holding section 25a formed in the restricted section 25 of the operation member 20 and is held in the initial position by the biasing force of the biasing spring 37 (see FIG. 10). The first action protruding section 41a of the action lever 38 is pressed against the lever holding section 25a of the restricted section 25 by the biasing force of the spring member 42, and the turn of the first action protruding section 41a is restricted. The second action protruding section 41b is positioned apart from the acted section 36 of the lock lever 32.

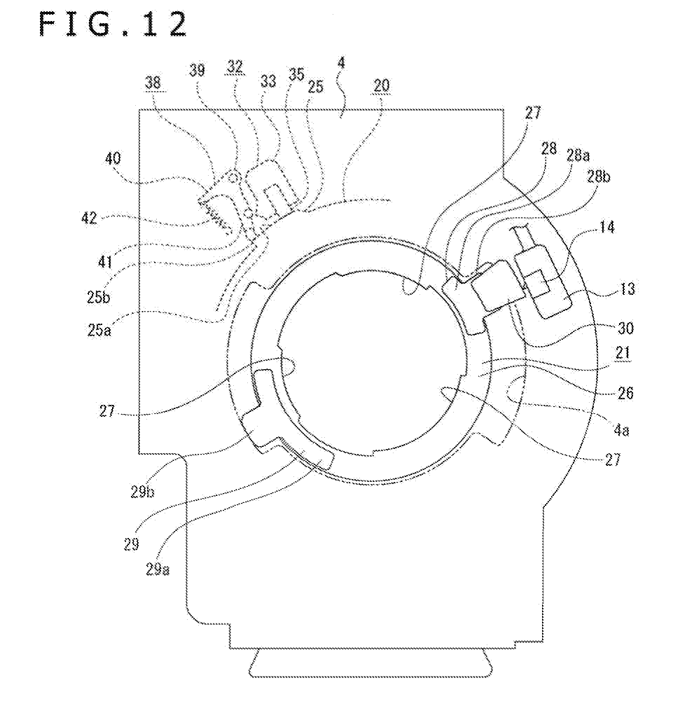

In the initial state, the switch operation section 30 attached to the joining plate 28, which joins the operation member 20 and the engagement member 21 to each other, is made to operate the operation switch 14, and the operation switch 14 is in the on state (see FIG. 12). In the initial state, consequently, the communication-disabled mode in which data communication between the interchangeable lens 50 and the imaging apparatus 1 is disabled is set.

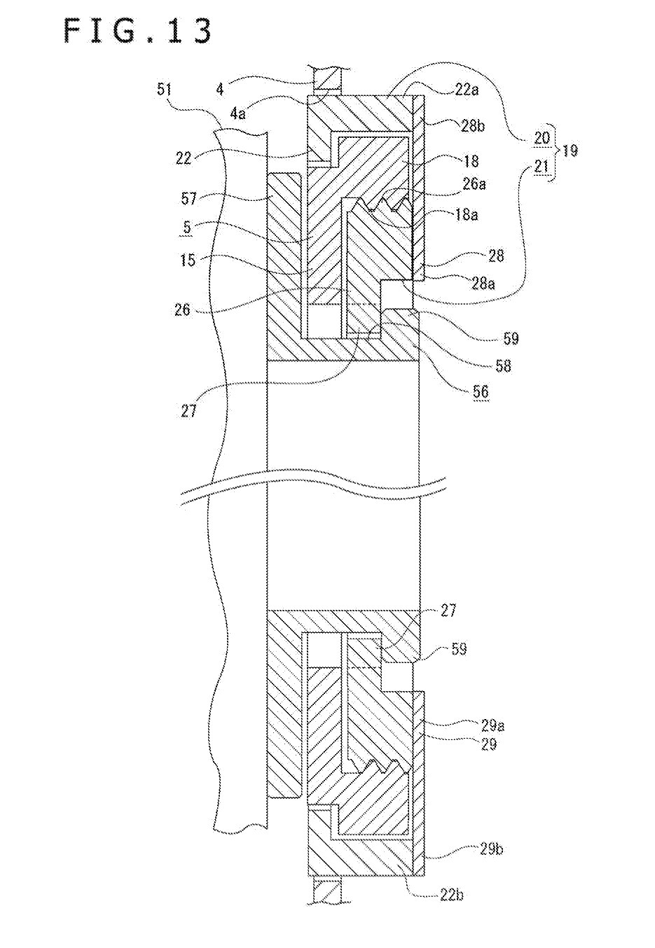

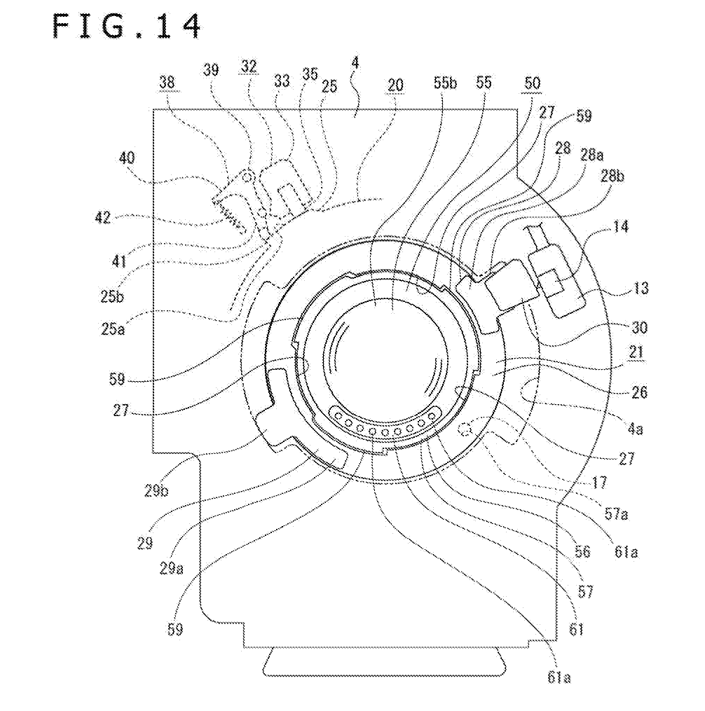

In the initial state described above, each of the coupling sections 59, 59, and 59 of the coupling ring 56 of the interchangeable lens 50 is inserted from the front between the engagement sections 27, 27, and 27 of the engagement member 21 (see FIGS. 13 and 14). In this case, the coupling ring 56 is positioned with the base ring section 57 facing the base section 15 of the mount section 5, and the alignment pin 17 is inserted into the alignment hole 57a. It is noted that marks are desirably placed on the interchangeable lens 50 and the imaging apparatus 1 so that the positions of the alignment hole 57a and the alignment pin 17 are aligned with each other when the interchangeable lens 50 is attached to the mount section 5.

Inserting the alignment pin 17 into the alignment hole 57a aligns the coupling ring 56 with the mount section 5. With the coupling ring 56 aligned with the mount section 5, each of the terminals 61a, 61a, . . . of the interchangeable lens 50 is positioned facing a corresponding one of the contacts 10a, 10a, . . . of the imaging apparatus 1, and both thereof are made into a couplable state.

Next, the operation lever 19 is operated to be rotated in one direction. The operation lever 19 is operated to be rotated by the user placing his/her finger on one of the finger-hook protruding sections 24 of the operation member 20, for example.

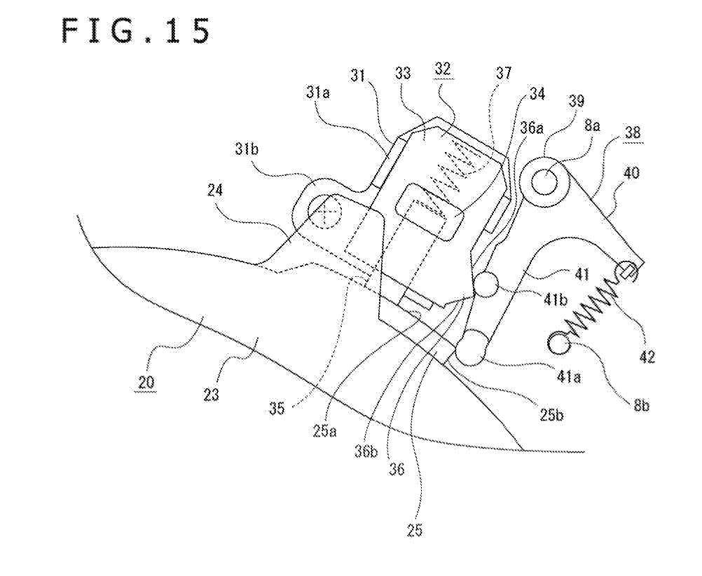

When the operation lever 19 is rotated in one direction, the sliding section 35 of the lock lever 32 slides on the lever holding section 25a of the restricted section 25 (see FIG. 15). The first action protruding section 41a of the action lever 38 is brought into contact with a boundary portion between the lever holding section 25a and the stopped section 25b of the restricted section 25 and is turned by the biasing force of the spring member 42. The second action protruding section 41b is pressed against the first acted edge 36a of the acted section 36. Consequently, in addition to the biasing force of the biasing spring 37, the biasing force in the direction from the initial position to the rotation restricting position is applied to the lock lever 32 by the spring member 42.

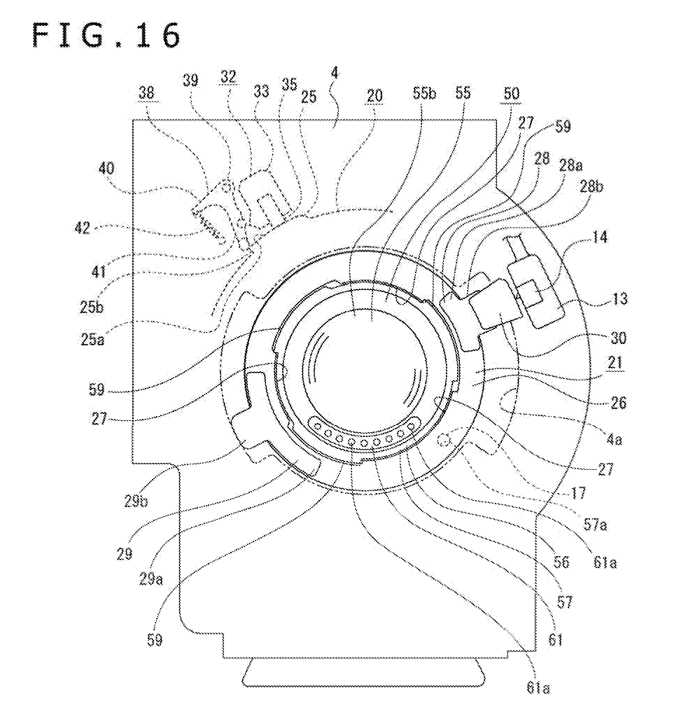

In this case, each part of the engagement sections 27, 27, and 27 is positioned at a rear side of a corresponding one of the coupling sections 59, 59, and 59 of the coupling ring 56 by the rotation of the operation lever 19, with each part of the engagement sections 27, 27, and 27 overlapping with each part of the coupling sections 59, 59, and 59 in the front-rear direction, respectively (see FIG. 16). In this case, the switch operation section 30 is still made to operate the operation switch 14, and the operation switch 14 is in the on state.

The rotation of the operation lever 19 causes the thread engagement position of the thread groove section 26a with respect to the thread engagement section 18a to be changed and moved rearward, causing the ring-shaped section 26 of the engagement member 21 to be separated rearward from the base section 15 of the mount section 5. Consequently, each of the coupling sections 59, 59, and 59 of the coupling ring 56 is pressed rearward by the corresponding one of the engagement sections 27, 27, and 27 of the engagement member 21.

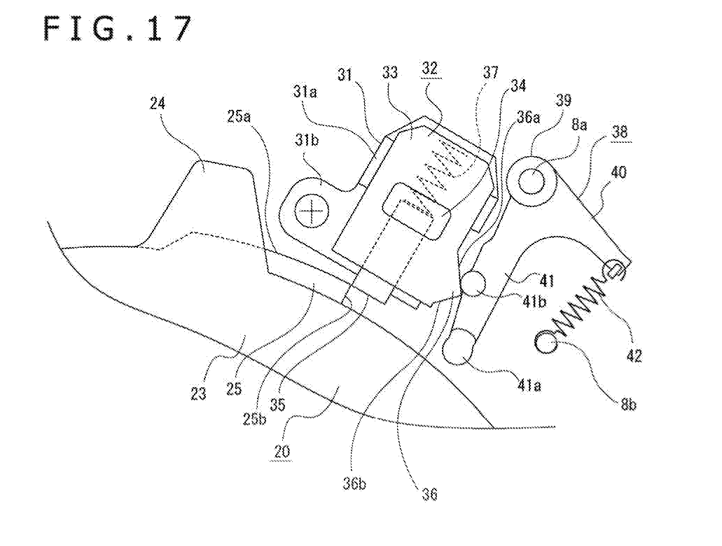

When the operation lever 19 is further operated to be rotated in one direction, the sliding section 35 of the lock lever 32 further slides on the lever holding section 25a of the restricted section 25 and the sliding section 35 is brought into contact with an end portion of the lever holding section 25a on the stopped section 25b side (see FIG. 17). The first action protruding section 41a of the action lever 38 is separated from the restricted section 25 and slightly turned in the direction in which the first action protruding section 41a approaches the operation member 20. Meanwhile, the second action protruding section 41b continues to be pressed against the first acted edge 36a of the acted section 36. Consequently, in addition to the biasing force of the biasing spring 37, the biasing force in the direction from the initial position to the rotation restricting position is still applied to the lock lever 32 by the spring member 42.

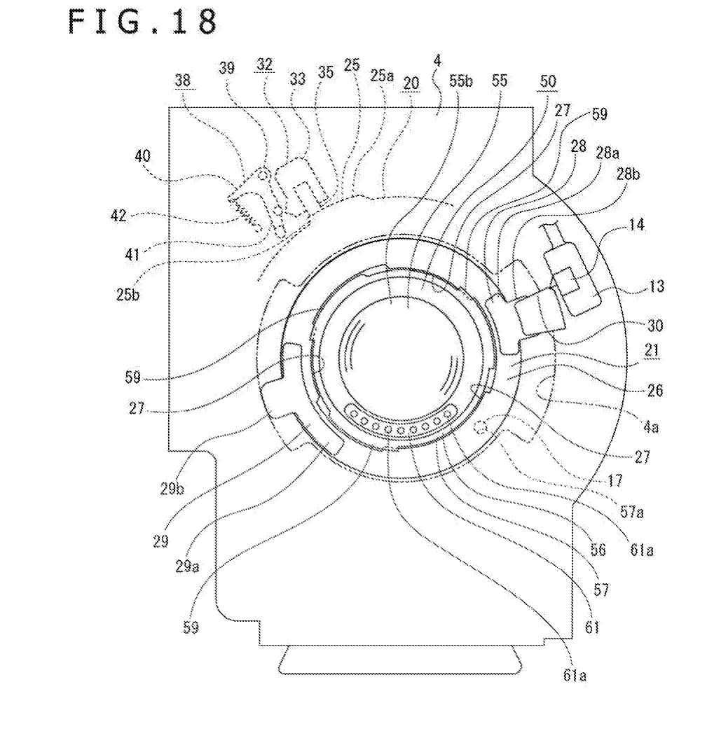

In this case, the rotation of the operation lever 19 increases the amount of overlapping between the engagement sections 27, 27, and 27 and the coupling sections 59, 59, and 59 in the front and rear (see FIG. 18). In this case, the switch operation section 30 is separated from the operation switch 14, and the operation switch 14 is made into the off state.

The rotation of the operation lever 19 causes the thread engagement position of the thread groove section 26a with respect to the thread engagement section 18a to be changed and moved rearward further, causing the ring-shaped section 26 of the engagement member 21 to be separated rearward further from the base section 15 of the mount section 5. Each of the coupling sections 59, 59, and 59 of the coupling ring 56 is pressed rearward further by the corresponding one of the engagement sections 27, 27, and 27 of the engagement member 21.

In this case, as the coupling sections 59, 59, and 59 are pressed rearward by the engagement sections 27, 27, and 27, the terminal section 61 of the interchangeable lens 50 is pressed against the contact section 10 of the imaging apparatus 1, and each of the terminals 61a, 61a, . . . is coupled to the corresponding one of the contacts 10a, 10a, . . . . Furthermore, as described above, the operation switch 14 is made into the off state and the communication-enabled mode in which the data communication between the interchangeable lens 50 and the imaging apparatus 1 is enabled is set.

In the imaging apparatus 1, when the terminal 61a, which is positioned at one end among the terminals 61a, 61a, . . . , is coupled to the contact 10a, which is positioned at one end among the contacts 10a, 10a, . . . , and the operation switch 14 is made into the off state, the communication-enabled mode is set.

As described above, in the imaging apparatus 1, the communication-enabled mode and the communication-disabled mode are switched according to the operation state of the switch operation section 30 with respect to the operation switch 14 along with the rotation of the operation lever 19.

Consequently, since the communication-enabled mode and the communication-disabled mode are switched according to the attachment or detachment state of the interchangeable lens 50 with respect to the mount section 5 by the rotation of the operation lever 19, it is not necessary to perform an operation of switching the mode, except the operation of rotating the operation lever 19. Thus, the usability of the imaging apparatus 1 can be improved.

Furthermore, the communication-enabled mode is set when the operation switch 14 is made into a predetermined detection state (off state) with the terminal 61a coupled to the contact 10a.

Consequently, when the terminal 61a is coupled to the contact 10a and the operation switch 14 is made into the off state by the operation of rotating the operation lever 19, the communication-enabled mode is set. As a result, only when the interchangeable lens 50 is attached to the mount section 5 in an appropriate state and the terminal 61a is coupled to the contact 10a, the communication-enabled mode is set. Thus, only when the interchangeable lens 50 is attached to the mount section 5 in an appropriate state, the data communication is performed between the interchangeable lens 50 and the imaging apparatus 1. This makes it possible to prevent an erroneous operation related to the communication with the interchangeable lens 50.

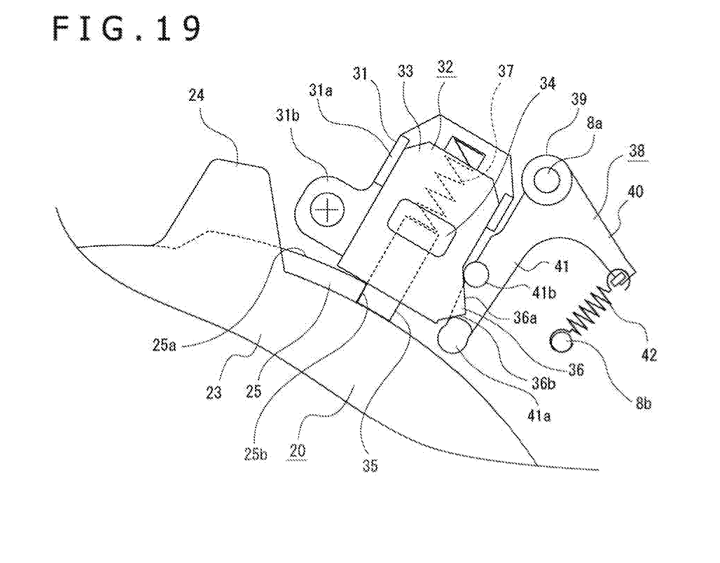

When the operation lever 19 is continuously operated to be rotated in one direction, the operation lever 19 reaches the locking position and the sliding section 35 of the lock lever 32 is separated from the restricted section 25 (see FIG. 19). When the lock lever 32 is separated from the restricted section 25, the lock lever 32 is moved to the rotation restricting position by the biasing force of the biasing spring 37 and the biasing force of the spring member 42 through the action lever 38.

In this manner, the imaging apparatus 1 includes the spring member 42 that biases the action lever 38 in one turning direction. The lock lever 32 is moved to the rotation restricting position by the biasing forces of the biasing spring 37 and the spring member 42.

Consequently, when the lock lever 32 is moved toward the rotation restricting position, not only the biasing force of the biasing spring 37 but also the biasing force of the spring member 42 that biases the action lever 38 are applied to the lock lever 32. Thus, it is possible to reliably move the lock lever 32 to the rotation restricting position with the improved functionality of the spring member 42.

With the lock lever 32 moved to the rotation restricting position, the sliding section 35 of the lock lever 32 is positioned facing the stopped section 25b of the restricted section 25 in the circumferential direction of the operation member 20. Thus, the rotation of the operation lever 19 in the direction opposite to one direction is restricted. Consequently, the operation lever 19 is locked by the lock lever 32.

As described above, with the interchangeable lens 50 locked to the mount section 5, at least a part of the lock lever 32 is covered from the front by the interchangeable lens 50 locked to the mount section 5.

Consequently, since at least a part of the lock lever 32 is covered by the interchangeable lens 50 with the interchangeable lens 50 locked to the mount section 5, the lock lever 32 is less likely to be touched by the hand during the use of the imaging apparatus 1 such as the photographing action and the interchangeable lens 50 is less likely to be unlocked erroneously. Thus, it is possible to prevent the interchangeable lens 50 from dropping off from the mount section 5 during the use of the imaging apparatus 1.

Furthermore, as described above, with the interchangeable lens 50 locked to the mount section 5, at least a part of the action lever 38 is covered from the front by the interchangeable lens 50 locked to the mount section 5.

Consequently, since at least a part of the action lever 38 is covered by the interchangeable lens 50 with the interchangeable lens 50 locked to the mount section 5, the action lever 38 is less likely to be touched by the hand during the use of the imaging apparatus 1 such as the photographing action and the interchangeable lens 50 is less likely to be unlocked erroneously. Thus, it is possible to prevent the interchangeable lens 50 from dropping off from the mount section 5 during the use of the imaging apparatus 1.

In this case, the rotation of the operation lever 19 further increases the amount of overlapping between the engagement sections 27, 27, and 27 and the coupling sections 59, 59, and 59 in the front and rear.

The rotation of the operation lever 19 causes the thread engagement position of the thread groove section 26a with respect to the thread engagement section 18a to be changed and moved rearward further, causing the ring-shaped section 26 of the engagement member 21 to be separated rearward further from the base section 15 of the mount section 5. Each of the coupling sections 59, 59, and 59 of the coupling ring 56 is pressed further rearward by the corresponding one of the engagement sections 27, 27, and 27 of the engagement member 21.

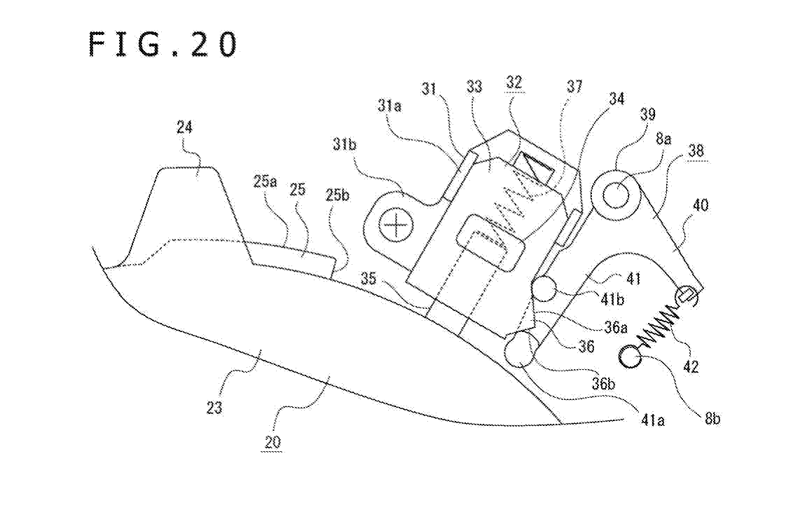

When the operation lever 19 is continuously operated to be rotated in one direction, the operation lever 19 reaches the fixing position and the sliding section 35 of the lock lever 32 is relatively separated from the restricted section 25 (see FIG. 20). The second action protruding section 41b of the action lever 38 continues to be pressed against the first acted edge 36a of the acted section 36.

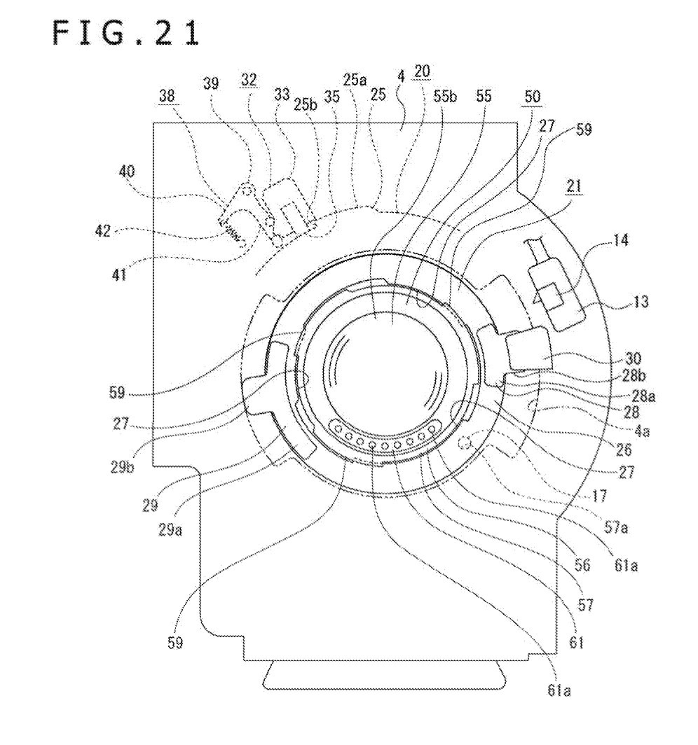

In this case, the rotation of the operation lever 19 further increases the amount of overlapping between the engagement sections 27, 27, and 27 and the coupling sections 59, 59, and 59 in the front and rear (see FIG. 21).

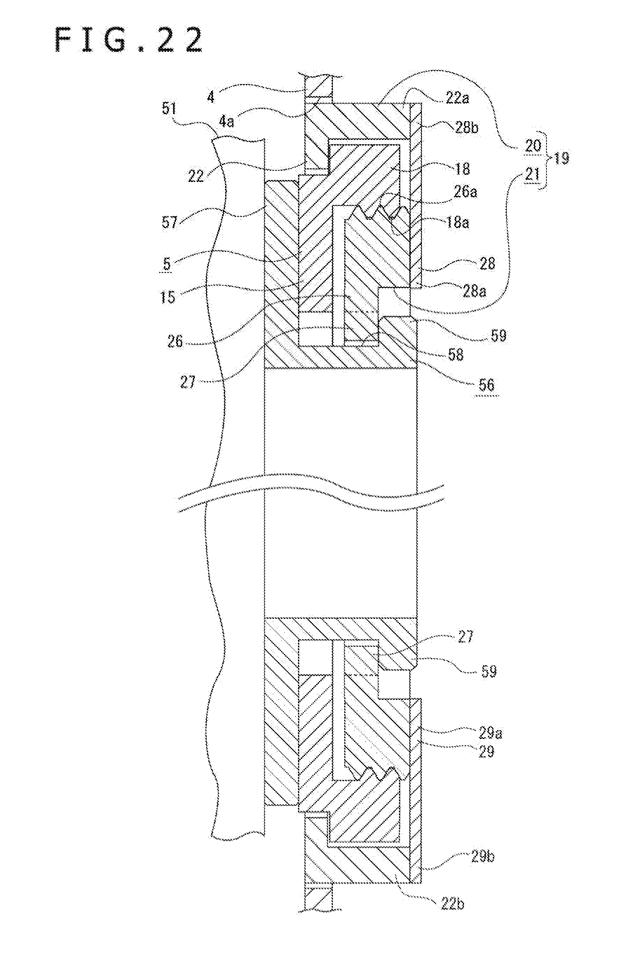

The rotation of the operation lever 19 causes the thread engagement position of the thread groove section 26a with respect to the thread engagement section 18a to be changed and moved rearward further, causing the ring-shaped section 26 of the engagement member 21 to be separated rearward further from the base section 15 of the mount section 5. Each of the coupling sections 59, 59, and 59 of the coupling ring 56 is pressed rearward further by the corresponding one of the engagement sections 27, 27, and 27 of the engagement member 21 (see FIG. 22). Consequently, when the coupling ring 56 is moved rearward, the base ring section 57 is pressed from the front against the base section 15 of the mount section 5 and brought into close contact therewith. This fixes the interchangeable lens 50 to the mount section 5.

As described above, the engagement sections 27, 27, and 27 are pressed against the coupling sections 59, 59, and 59 according to the thread engagement state of the thread groove section 26a of the operation lever 19 with respect to the thread engagement section 18a of the mount section 5. This fixes the interchangeable lens 50 to the mount section 5.

Consequently, with the interchangeable lens 50 fixed to the mount section 5, the engagement sections 27, 27, and 27 are pressed against the coupling sections 59, 59, and 59 and the interchangeable lens 50 is pressed against the mount section 5. Thus, while the interchangeable lens 50 is in a fixed state with respect to the mount section 5, it is possible to prevent the interchangeable lens 50 from rattling against the imaging apparatus 1, thereby securing a favorable photographing condition.

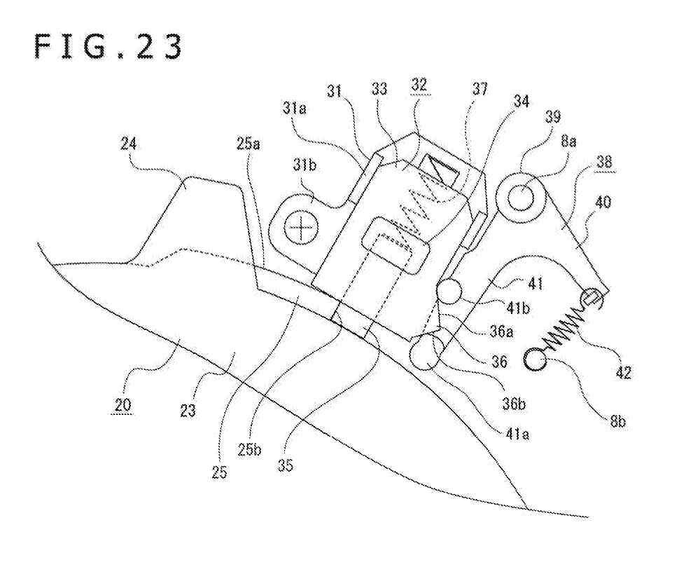

Next, description will be made with regard to actions when the interchangeable lens 50 fixed to the mount section 5 as described above is detached from the mount section 5 (see FIGS. 23 to 26). The interchangeable lens 50 is detached from the mount section 5 by an operation of rotating the operation lever 19 in the other direction, which is opposite to the above-described one direction.

It is noted that as for the actions when the interchangeable lens 50 is detached from the mount section 5, the action related to the operation of the switch operation section 30 with respect to the operation switch 14, the action related to the engagement of the coupling sections 59, 59, and 59 with respect to the engagement sections 27, 27, and 27, and the action related to the change in the thread engagement position of the thread groove section 26a with respect to the thread engagement section 18a are actions that are opposite to the above-described actions when the interchangeable lens 50 is attached to the mount section 5.

Consequently, hereinafter, description will be made only with regard to the actions of the lock lever 32 and the action lever 38 when the interchangeable lens 50 is detached from the mount section 5. Description with regard to the action related to the operation of the switch operation section 30 with respect to the operation switch 14, the action related to the engagement of the coupling sections 59, 59, and 59 with respect to the engagement sections 27, 27, and 27, and the action related to the change in the thread engagement position of the thread groove section 26a with respect to the thread engagement section 18a will be omitted.

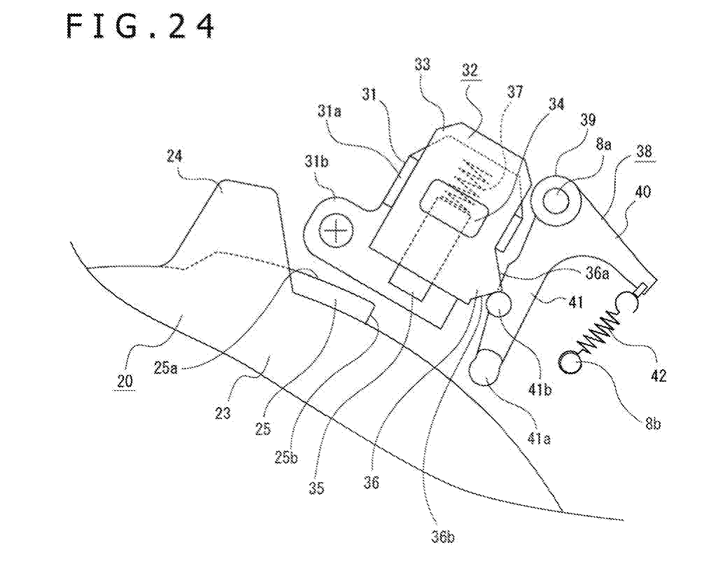

When the operation lever 19 is operated to be rotated in the other direction from the fixing position, the operation lever 19 reaches the locking position and the stopped section 25b of the restricted section 25 is brought into contact with the sliding section 35 of the lock lever 32 positioned in the rotation restricting position, thereby restricting the rotation of the operation lever 19 in the other direction (see FIG. 23). In this case, the user operates the knob section 34 of the lock lever 32 and moves the lock lever 32 to the rotation allowable position (see FIG. 24).

When the lock lever 32 is moved toward the rotation allowable position, the acted section 36 of the lock lever 32 slides on the second action protruding section 41b of the action lever 38 and the second acted edge 36b of the acted section 36 is brought into contact with the second action protruding section 41b. In this case, the biasing force of the spring member 42 is applied to the action lever 38. Thus, with the lock lever 32 moved to the rotation allowable position, the second action protruding section 41b is pressed against the second acted edge 36b. Consequently, the lock lever 32 is held in the rotation allowable position by the action lever 38 to which the biasing force of the spring member 42 is applied. Even when the finger is released from the knob section 34, the lock lever 32 does not move toward the rotation restricting position.

It is noted that the user's operation of moving the lock lever 32 from the rotation restricting position to the rotation allowable position may be performed in any position until the operation lever 19 is rotated from the fixing position to the locking position. Consequently, when the interchangeable lens 50 is detached from the mount section 5, the lock lever 32 may be operated to be moved from the rotation restricting position to the rotation allowable position in a state where, for example, the operation lever 19 is positioned in the fixing position before the operation lever 19 is rotated in the other direction.

When the lock lever 32 has been moved to the rotation allowable position, the sliding section 35 is separated outward from the operation member 20. Accordingly, the operation lever 19 locked by the lock lever 32 is unlocked and allowed to be further rotated in the other direction.

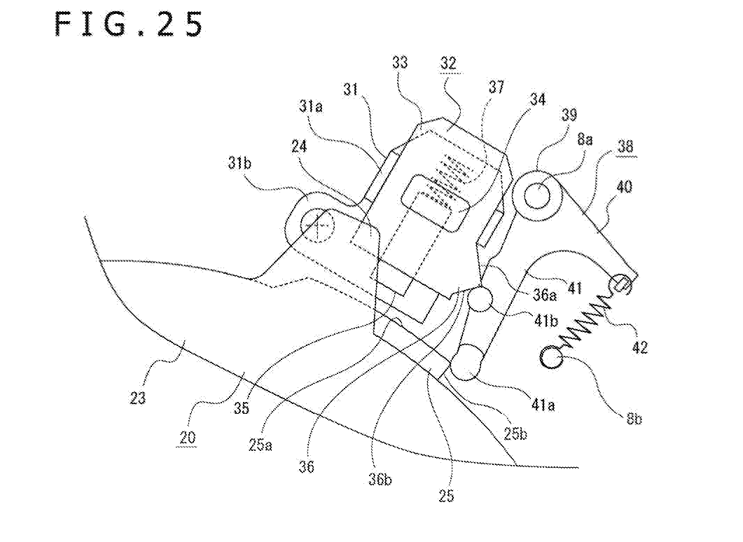

When the operation lever 19 is continuously operated to be rotated in the other direction, the restricted section 25 passes on an inner side of the lock lever 32, the second action protruding section 41b of the action lever 38 is pressed by the restricted section 25 against the biasing force of the spring member 42, and the action lever 38 is turned against the biasing force of the spring member 42 (see FIG. 25).

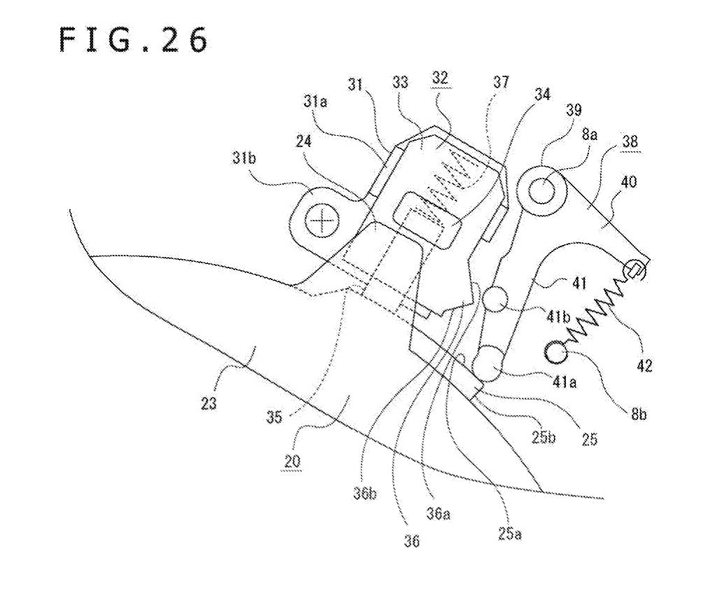

When the operation lever 19 is further operated to be rotated in the other direction, the operation lever 19 reaches the attachable position and the first action protruding section 41a of the action lever 38 turned against the biasing force of the spring member 42 rides onto the lever holding section 25a from the stopped section 25b of the restricted section 25 (see FIG. 26). In this case, the second action protruding section 41b of the action lever 38 is separated from the acted section 36 of the lock lever 32. Accordingly, the lock lever 32 is moved from the rotation allowable position to the rotation restricting position by the biasing force of the biasing spring 37, and the sliding section 35 is pressed against the lever holding section 25a of the restricted section 25, thereby holding the lock lever 32 in the initial position. The first action protruding section 41a of the action lever 38 is pressed against the lever holding section 25a of the restricted section 25 by the biasing force of the spring member 42 and the turn of the first action protruding section 41a is restricted. Consequently, both of the lock lever 32 and the action lever 38 return to the initial state.

Since the operation lever 19 is positioned in the attachable position and is in the initial state, each of the coupling sections 59, 59, and 59 of the interchangeable lens 50 is positioned between the engagement sections 27, 27, and 27 of the engagement member 21. Consequently, the interchangeable lens 50 can be detached from the mount section 5 by pulling the coupling sections 59, 59, and 59 forward from the mount section 5.

As described above, in the imaging apparatus 1, the lock lever 32 is movable between the rotation allowable position in which the rotation of the operation lever 19 is allowed and the rotation restricting position in which the rotation of the operation lever 19 is restricted. The operation lever 19 includes the restricted section 25. The lock lever 32 moved to the rotation restricting position can contact the restricted section 25 in the locking position.

Consequently, since the interchangeable lens 50 is locked to the mount section 5 by the lock lever 32 moved to the rotation restricting position, the interchangeable lens 50 can be locked to the mount section 5 with the simple configuration.

Furthermore, the biasing spring 37 and the action lever 38 are provided. The biasing spring 37 biases the lock lever 32 in the direction in which the lock lever 32 is moved from the rotation allowable position to the rotation restricting position. The action lever 38 is turnable with respect to the housing 2 and holds the lock lever 32 in the rotation allowable position.

Consequently, since the lock lever 32 is held by the action lever 38 in the rotation allowable position and the movement of the lock lever 32 to the rotation restricting position is restricted, it is not necessary to hold the lock lever 32 when rotating the operation lever 19 from the locking position to the attachable position. It is sufficient if the imaging apparatus 1 is held by one hand and the operation lever 19 is operated by the other hand. Accordingly, it is possible to perform the operation of rotating the lock lever 32 easily and reliably.

In addition, the spring constant of the spring member 42 is larger than the spring constant of the biasing spring 37. When the operation lever 19 is rotated from the attachable position to the fixing position, the biasing force of the spring member 42 is exerted on the lock lever 32 through the action lever 38 in the direction in which the lock lever 32 is moved from the rotation allowable position to the rotation restricting position. When the operation lever 19 is moved from the fixing position to the attachable position, the biasing force of the spring member 42 is exerted on the lock lever 32 through the action lever 38 in the direction in which the lock lever 32 is moved from the rotation restricting position to the rotation allowable position.

Consequently, when the operation lever 19 is rotated in the opposite direction, the biasing force of the spring member 42 is exerted on the lock lever 32 in the corresponding opposite direction. Thus, it is not necessary to provide different springs that exert the biasing force on the lock lever 32 in the respective opposite directions. Accordingly, it is possible to reduce the number of parts and simplify the structure.

Moreover, in the attachable position, the restricted section 25 restricts the movement of the lock lever 32, which is biased by the biasing spring 37, toward the rotation restricting position.

Consequently, since the lock lever 32 is moved to the rotation restricting position by the restricted section 25 that is contacted by the lock lever 32 and that is involved in the restriction of the rotation of the interchangeable lens 50, it is possible to simplify the structure with the restricted section 25 that is used for both the restriction of the movement of the lock lever 32 and the restriction of the rotation of the interchangeable lens 50 in the attachable position.

### <Time Chart for Actions>

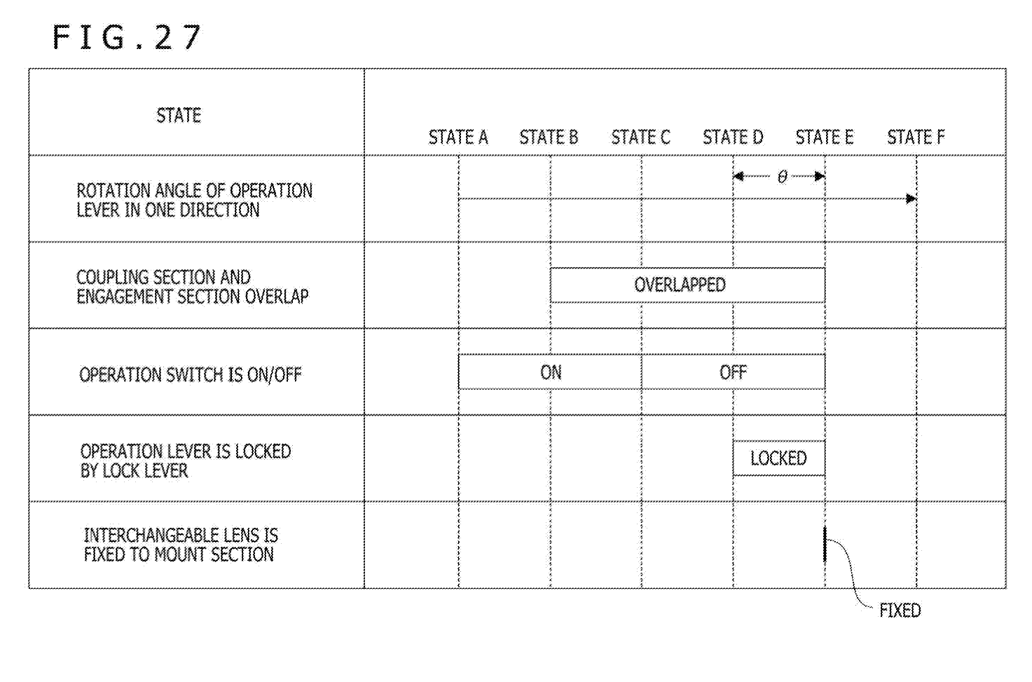

Next, description will be made with regard to timing for actions when the above-described interchangeable lens 50 is attached to the mount section 5 (see FIG. 27).

FIG. 27 is a time chart for the rotation angle of the operation lever 19 in one direction, the overlapping state between the coupling sections 59 of the interchangeable lens 50 and the engagement sections 27 of the operation lever 19 in the front-rear direction, the on/off state of the operation switch 14, the locked state of the operation lever 19 by the lock lever 32, and the fixed state of the interchangeable lens 50 with respect to the mount section 5.

A state A indicates the initial state. In the state A, the operation lever 19 is positioned in the attachable position, and the rotation angle is 0 degrees. The coupling sections 59 and the engagement sections 27 do not overlap with each other. The operation switch 14 is in the on state. The lock lever 32 is in the initial position and the operation lever 19 is not locked. The interchangeable lens 50 is not fixed to the mount section 5.

A state B indicates a state immediately after the operation lever 19 has been rotated in one direction, with each of the coupling sections 59, 59, and 59 of the interchangeable lens 50 inserted between the engagement sections 27, 27, and 27 of the engagement member 21. In the state B, the operation lever 19 has been rotated by a predetermined angle from the attachable position. The coupling sections 59 and the engagement sections 27 have started overlapping with each other. The operation switch 14 is in the on state. The lock lever 32 is in the initial position and the operation lever 19 is not locked. The interchangeable lens 50 is not fixed to the mount section 5.

A state C indicates a state where the operation lever 19 has been rotated in one direction, continuing from the state B. In the state C, the operation lever 19 has been rotated to a position between the attachable position and the locking position. The overlapping between the coupling sections 59 and the engagement sections 27 has been increased from the state B. The operation switch 14 is in the off state. The lock lever 32 is in the initial position and the operation lever 19 is not locked. The interchangeable lens 50 is not fixed to the mount section 5.

A state D indicates a state where the operation lever 19 has been rotated in one direction, continuing from the state C. In the state D, the operation lever 19 has been rotated from the attachable position to the locking position. The overlapping between the coupling sections 59 and the engagement sections 27 has been increased from the state C. The operation switch 14 is in the off state. The lock lever 32 is in the locking position and the operation lever 19 is locked. The interchangeable lens 50 is not fixed to the mount section 5.

A state E indicates a state where the operation lever 19 has been rotated in one direction, continuing from the state D. In the state E, the operation lever 19 has been rotated from the attachable position to the fixing position. The overlapping between the coupling sections 59 and the engagement sections 27 has been increased from the state D. The operation switch 14 is in the off state. The lock lever 32 is in the locking position and the operation lever 19 is locked. The interchangeable lens 50 is fixed to the mount section 5.

As described above, in the imaging apparatus 1, after the operation switch 14 is made into the off state (state C) by the rotation of the operation lever 19 in one direction, the operation lever 19 is locked by the lock lever 32 (state D). After the operation lever 19 has been locked, the interchangeable lens 50 is fixed to the mount section 5 (state E).

In this manner, in the imaging apparatus 1, the communication-enabled mode is set when the operation switch 14 is made into a predetermined detection state (off state) while the operation lever 19 is being rotated from the attachable position to the locking position.

Consequently, since the communication-enabled mode is set while the operation lever 19 is being rotated from the attachable position to the locking position, it is possible to always communicate with the interchangeable lens 50 with the interchangeable lens 50 locked to the mount section 5, and it is possible to improve the usability while the interchangeable lens 50 is being attached to the mount section 5.

Furthermore, in the imaging apparatus 1, the rotation angle θ of the operation lever 19 from the state D where the operation lever 19 is locked to the state E where the interchangeable lens 50 is fixed is 15 degrees or more and 25 degrees or less.

Consequently, the operation of rotating the operation lever 19 by 15 degrees or more and 25 degrees or less from the locking position fixes the interchangeable lens 50 to the mount section 5. Thus, it is possible to effortlessly operate the operation lever 19 from the locking position to the fixing position and fix the interchangeable lens 50 without changing the hand. Accordingly, it is possible to secure high operability for the operation lever 19.

It is noted that with the interchangeable lens 50 detached from the mount section 5 in the imaging apparatus 1, the operation lever 19 is further rotatable in one direction from the rotation position in the state (state E) where the interchangeable lens 50 is fixed to the mount section 5 to the rotation position in a state F. Furthermore, in the rotation position in the state A and the rotation position in the state F, both of the rotations of the operation lever 19 in the other direction and in one direction are restricted by respective stoppers, not illustrated.

Furthermore, in the above description, the lock lever 32 may be moved by manual operation between the rotation allowable position and the rotation restricting position for rotation of the operation lever 19 from the rotation allowable position to the rotation restricting position.

### <One Embodiment of Imaging Apparatus>

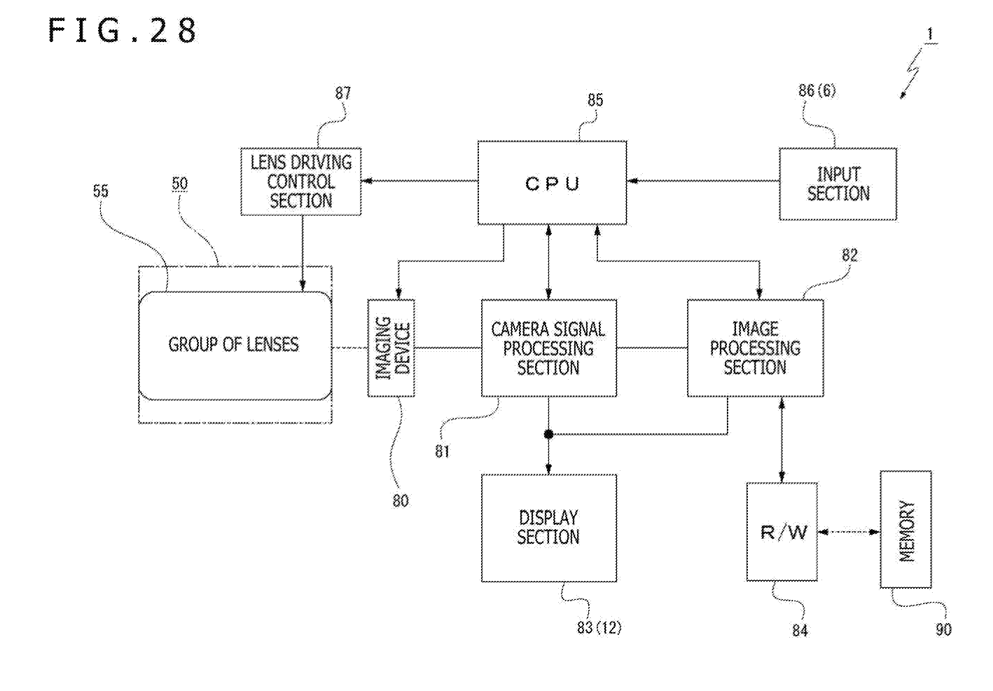

A block diagram of the video camera according to one embodiment of the imaging apparatus of the present technology will be depicted below (see FIG. 28).

The imaging apparatus (video camera) 1 includes an imaging device 80, a camera signal processing section 81, and an image processing section 82. The imaging device 80 has a photoelectric conversion function of converting captured light into an electric signal. The camera signal processing section 81 performs signal processing such as analog-digital conversion of a signal of a photographed image. The image processing section 82 performs recording and reproducing processing on the image signal. Furthermore, the imaging apparatus 1 includes a display section 83 (display 12), a reader/writer (R/W) 84, a central processing unit (CPU) 85, an input section 86 (operation sections 6), and a lens driving control section 87. The display section 83 (display 12) displays the photographed image and the like. The R/W 84 writes and reads the image signal into and from a memory 90. The CPU 85 controls the entire imaging apparatus 1. The user performs necessary operations on the input section 86 (operation sections 6) such as various switches. The lens driving control section 87 controls driving of the lens provided in the interchangeable lens 50.

The camera signal processing section 81 performs various signal processing such as conversion of an output signal received from the imaging device 80 into a digital signal, removal of noise, correction of image quality, conversion into a luminance/color difference signal.

The image processing section 82 performs, on the image signal, compression encoding/decompression decoding processing based on a predetermined image data format, processing of converting data specification such as resolution, and the like.

The display section 83 has a function of displaying a state of the user's operation on the input section 86 and various data such as a photographed image.

The R/W 84 writes the image data encoded by the image processing section 82 into the memory 90 and reads the image data recorded into the memory 90.

The CPU 85 functions as a control processing section that controls each circuit block provided in the imaging apparatus 1, and controls each circuit block on the basis of an instruction input signal and the like received from the input section 86.

The input section 86 outputs, to the CPU 85, the instruction input signal according to the user's operation.

The lens driving control section 87 controls a motor, not illustrated, that drives the group of lenses 55, 55, . . . on the basis of a control signal received from the CPU 85, and the like.

The memory 90 is, for example, a semiconductor memory that is attachable to and detachable from a slot coupled to the R/W 84.

Hereinafter, the actions of the imaging apparatus 1 will be described.

In a photographing standby state, a signal of a photographed image is output to the display section 83 through the camera signal processing section 81 and displayed as a camera through image under the control by the CPU 85. Furthermore, when an instruction input signal for zooming is input from the input section 86, the CPU 85 outputs a control signal to the lens driving control section 87 and the predetermined group of lenses 55 are moved on the basis of the control by the lens driving control section 87.

When photographing is performed in response to the instruction input signal received from the input section 86, the signal of the photographed image is output from the camera signal processing section 81 to the image processing section 82 and converted into digital data in a predetermined data format through the compression encoding processing. The converted data is output to the R/W 84 and written into the memory 90.

Focusing is performed by the lens driving control section 87 causing the predetermined group of lenses 55 to move on the basis of the control signal received from the CPU 85.

In a case where the image data recorded into the memory 90 is reproduced, the R/W 84 reads the predetermined image data from the memory 90 according to the operation on the input section 86. After the image processing section 82 performs the decompression decoding processing, a reproduction image signal is output to the display section 83 and a reproduction image is displayed.

### <Conclusion>

As described above, in the imaging apparatus 1, the rotation positions of the operation lever 19 include, in order of the rotation in one direction, the attachable position, the locking position, and the fixing position. In the attachable position, the interchangeable lens 50 is attachable to the mount section 5. In the locking position, the interchangeable lens 50 is held by the lock lever 32 such that the interchangeable lens 50 is undroppable from the mount section 5. In the fixing position, the interchangeable lens 50 is held in close contact with the mount section 5. The fixing position is the rotation end of the operation lever 19.

Consequently, the rotation of the operation lever 19 in one direction from the attachable position fixes the interchangeable lens 50 to the mount section 5 after locking the interchangeable lens 50 to the mount section 5. Thus, it is possible to improve image quality by preventing the interchangeable lens 50 from rattling against the mount section 5 with the interchangeable lens 50 locked to the mount section 5.

Furthermore, the operation lever 19 includes the operation member 20 and the engagement member 21 joined to each other. The thread groove section 26a and the engagement sections 27, 27, and 27 are formed in the engagement member 21.

Consequently, since the thread groove section 26a and the engagement sections 27, 27, and 27 are formed in one member, the positional relationship between the thread groove section 26a and the engagement sections 27, 27, and 27 does not change. When the thread groove section 26a is made into a constant thread engagement state with respect to the thread engagement section 18a, the interchangeable lens 50 is fixed to the mount section 5. This makes it possible to secure a stable fixed state of the interchangeable lens 50 with respect to the mount section 5.

In addition, the joining plate 28 joining the operation member 20 and the engagement member 21 to each other is provided. The switch operation section 30 is attached to the joining plate 28.

Consequently, the joining plate 28 has a function of joining the operation member 20 and the engagement member 21 to each other, while functioning as an attachment plate to which the switch operation section 30 is attached. Since it is not necessary to separately provide a member for joining the operation member 20 and the engagement member 21 to each other and a member to which the switch operation section 30 is attached, it is possible to improve functionality while reducing the number of parts.

Moreover, the interchangeable lens 50 is used as an accessory. Thus, the rotation of the operation lever 19 in one direction from the attachable position fixes the interchangeable lens 50 to the mount section 5 after locking the interchangeable lens 50 to the mount section 5.

Consequently, it is possible to improve image quality by preventing the interchangeable lens 50 from ratting against the mount section 5 with the interchangeable lens 50 locked to the mount section 5.

### <Present Technology>

The present technology can be configured as follows.

(1)

An imaging apparatus including:

a housing including a mount section to which an accessory is attachable;

a rotation operating section rotatably supported by the housing; and

a locking section configured to hold the accessory such that the accessory is undroppable from the mount section,

in which a rotation position of the rotation operating section includes:
in order of a rotation in one direction,
an attachable position in which the accessory is attachable to the mount section;
a locking position in which the accessory is held by the locking section such that the accessory is undroppable from the mount section; and
a fixing position in which the accessory is held in close contact with the mount section, the fixing position being a rotation end of the rotation operating section.
   (2)

The imaging apparatus according to (1),

in which the mount section includes a thread engagement section,

the rotation operating section includes:
a thread groove section whose thread engagement state with respect to the thread engagement section is changed according to a rotation angle with respect to the housing; and
an engagement section configured to be engaged with a coupling section included in the accessory, and

the accessory is fixed to the mount section by the engagement section being pressed against the coupling section according to the thread engagement state of the thread groove section with respect to the thread engagement section.

(3)

The imaging apparatus according to (2),

in which the rotation operating section includes an operation member and an engagement member joined to each other, and

the thread groove section and the engagement section are formed in the engagement member.

(4)

The imaging apparatus according to (3), further including a joining plate joining the operation member and the engagement member to each other,

in which a switch operation section is attached to the joining plate.

(5)

The imaging apparatus according to any one of (1) to (4), further including an operation switch configured to switch between a communication-enabled mode in which data communication with the accessory is enabled and a communication-disabled mode in which the data communication with the accessory is disabled,

in which the operation switch is operated along with the rotation of the rotation operating section.

(6)

The imaging apparatus according to (5), in which the communication-enabled mode is set when the operation switch is made into a predetermined detection state while the rotation operating section is being rotated from the attachable position to the locking position.

(7)

The imaging apparatus according to (5) or (6), further including a contact configured to detect, when a terminal of the accessory is coupled, that the data communication with the accessory has been set to enabled,

in which the communication-enabled mode is set when the operation switch is made into a predetermined detection state with the terminal coupled to the contact.

(8)

The imaging apparatus according to any one of (1) to (7), in which a rotation angle of the rotation operating section from the locking position to the fixing position is 15 degrees or more and 25 degrees or less.

(9)

The imaging apparatus according to any one of (1) to (8), in which the locking section is provided in a position in which at least a part of the locking section is covered by the accessory locked to the mount section.

(10)

The imaging apparatus according to any one of (1) to (9),

in which the locking section is movable between a rotation allowable position in which the rotation of the rotation operating section is allowed and a rotation restricting position in which the rotation of the rotation operating section is restricted, and

the rotation operating section includes a restricted section with which the locking section moved to the rotation restricting position is contactable in the locking position.

(11)

The imaging apparatus according to (10), further including:

a biasing spring configured to bias the locking section in a direction in which the locking section is moved from the rotation allowable position to the rotation restricting position; and

an action lever configured to be turnable with respect to the housing and hold the locking section in the rotation allowable position.

(12)

The imaging apparatus according to (11), further including a spring member configured to bias the action lever in one turning direction,

in which the locking section is moved toward the rotation restricting position by a biasing force of the biasing spring and a biasing force of the spring member.

(13)

The imaging apparatus according to (12),

in which a spring constant of the spring member is larger than a spring constant of the biasing spring,

when the rotation operating section is rotated from the attachable position to the fixing position, the biasing force of the spring member is exerted on the locking section through the action lever in the direction in which the locking section is moved from the rotation allowable position to the rotation restricting position, and

when the rotation operating section is rotated from the fixing position to the attachable position, the biasing force of the spring member is exerted on the locking section through the action lever in a direction in which the locking section is moved from the rotation restricting position to the rotation allowable position.

(14)

The imaging apparatus according to any one of (11) to (13), in which in the attachable position, the restricted section restricts movement of the locking section toward the rotation restricting position, the locking section being biased by the biasing spring.

(15)

The imaging apparatus according to (11) to (14), in which the action lever is provided in a position in which at least a part of the action lever is covered by the accessory locked to the mount section.

(16)

The imaging apparatus according to any one of (11) to (15), further including:

a knob section included in the locking section; and

a cover including an insertion hole into which the knob section is inserted and covering the action lever and a portion of the locking section excluding the knob section.

(17)

The imaging apparatus according to any one of (1) to (16), in which the accessory includes an interchangeable lens.

### REFERENCE SIGNS LIST

1 . . . Imaging apparatus, 2 . . . Housing, 5 . . . Mount section, 10a . . . Contact, 14 . . . Operation switch, 18a . . . Thread engagement section, 19 . . . Operation lever (rotation operating section), 20 . . . Operation member, 21 . . . Engagement member, 25 . . . Restricted section, 26a . . . Thread groove section, 27 . . . Engagement section, 28 . . . Joining plate, 30 . . . Switch operation section, 32 . . . Lock lever (locking section), 34 . . . Knob section, 37 . . . Biasing spring, 38 . . . Action lever, 42 . . . Spring member, 43 . . . Cover, 43a . . . Insertion hole, 50 . . . Interchangeable lens (accessory), 59 . . . Coupling section, 61a . . . Terminal

1. An imaging apparatus comprising:
a housing including a mount section to which an accessory is attachable;
a rotation operating section rotatably supported by the housing; and
a locking section configured to hold the accessory such that the accessory is undroppable from the mount section, wherein
a rotation position of the rotation operating section includes:
in order of a rotation in one direction,
an attachable position in which the accessory is attachable to the mount section;
a locking position in which the accessory is held by the locking section such that the accessory is undroppable from the mount section; and
a fixing position in which the accessory is held in close contact with the mount section, the fixing position being a rotation end of the rotation operating section.

2. The imaging apparatus according to claim 1, wherein
the mount section includes a thread engagement section,
the rotation operating section includes:
a thread groove section whose thread engagement state with respect to the thread engagement section is changed according to a rotation angle with respect to the housing; and
an engagement section configured to be engaged with a coupling section included in the accessory, and
the accessory is fixed to the mount section by the engagement section being pressed against the coupling section according to the thread engagement state of the thread groove section with respect to the thread engagement section.

3. The imaging apparatus according to claim 2, wherein
the rotation operating section includes an operation member and an engagement member joined to each other, and
the thread groove section and the engagement section are formed in the engagement member.

4. The imaging apparatus according to claim 3, further comprising:
a joining plate joining the operation member and the engagement member to each other, wherein
a switch operation section is attached to the joining plate.

5. The imaging apparatus according to claim 1, further comprising:
an operation switch configured to switch between a communication-enabled mode in which data communication with the accessory is enabled and a communication-disabled mode in which the data communication with the accessory is disabled, wherein
the operation switch is operated along with the rotation of the rotation operating section.

6. The imaging apparatus according to claim 5, wherein
the communication-enabled mode is set when the operation switch is made into a predetermined detection state while the rotation operating section is being rotated from the attachable position to the locking position.

7. The imaging apparatus according to claim 5, further comprising:
a contact configured to detect, when a terminal of the accessory is coupled, that the data communication with the accessory has been set to enabled, wherein
the communication-enabled mode is set when the operation switch is made into a predetermined detection state with the terminal coupled to the contact.

8. The imaging apparatus according to claim 1, wherein
a rotation angle of the rotation operating section from the locking position to the fixing position is 15 degrees or more and 25 degrees or less.

9. The imaging apparatus according to claim 1, wherein
the locking section is provided in a position in which at least a part of the locking section is covered by the accessory locked to the mount section.

10. The imaging apparatus according to claim 1, wherein
the locking section is movable between a rotation allowable position in which the rotation of the rotation operating section is allowed and a rotation restricting position in which the rotation of the rotation operating section is restricted, and
the rotation operating section includes a restricted section with which the locking section moved to the rotation restricting position is contactable in the locking position.

11. The imaging apparatus according to claim 10, further comprising:
a biasing spring configured to bias the locking section in a direction in which the locking section is moved from the rotation allowable position to the rotation restricting position; and
an action lever configured to be turnable with respect to the housing and hold the locking section in the rotation allowable position.

12. The imaging apparatus according to claim 11, further comprising:
a spring member configured to bias the action lever in one turning direction, wherein
the locking section is moved toward the rotation restricting position by a biasing force of the biasing spring and a biasing force of the spring member.

13. The imaging apparatus according to claim 12, wherein
a spring constant of the spring member is larger than a spring constant of the biasing spring,
when the rotation operating section is rotated from the attachable position to the fixing position, the biasing force of the spring member is exerted on the locking section through the action lever in the direction in which the locking section is moved from the rotation allowable position to the rotation restricting position, and
when the rotation operating section is rotated from the fixing position to the attachable position, the biasing force of the spring member is exerted on the locking section through the action lever in a direction in which the locking section is moved from the rotation restricting position to the rotation allowable position.

14. The imaging apparatus according to claim 11, wherein
in the attachable position, the restricted section restricts movement of the locking section toward the rotation restricting position, the locking section being biased by the biasing spring.

15. The imaging apparatus according to claim 11, wherein
the action lever is provided in a position in which at least a part of the action lever is covered by the accessory locked to the mount section.

16. The imaging apparatus according to claim 11, further comprising:
a knob section included in the locking section; and
a cover including an insertion hole into which the knob section is inserted and covering the action lever and a portion of the locking section excluding the knob section.

17. The imaging apparatus according to claim 1, wherein
the accessory includes an interchangeable lens.
